(19) United States
(12) Patent Application Publication
(10) Pub. No.: US 2024/0265532 A1
(43) Pub. Date: Aug. 8, 2024

(54) System and method for carrying out morphometric analysis of the vascularization of an organ

(71) Applicant: Biocellvia, Marseille (FR)

(72) Inventors: Cindy SERDJEBI, SEPTEMES-LES-VALLONS (FR); Damien BARBES, GRENOBLE (FR); Bastien LEPOIVRE, MARSEILLE (FR); Karine BERTOTTI, BRAX (FR)

(73) Assignee: Biocellvia, Marseille (FR)

(21) Appl. No.: 18/556,411

(22) PCT Filed: Apr. 19, 2022
(86) PCT No.: PCT/FR2022/050733

§ 371 Date: Oct. 20, 2023

(30) Foreign Application Priority Data
Apr. 22, 2021 (FR) FR2104200

(51) Int. Cl. G06T 7/00; G06T 7/62; G06V 20/69

(52) U.S. Cl. CPC G06T 7/0012; G06T 7/62; G06V 20/695; G06T 2207/10024; G06T 2207/20036; G06T 2207/30024; G06T 2207/30096; G06T 2207/30101

(57) ABSTRACT

The invention relates to a method for producing a morphometric quantity of interest for a section of a human or animal organ on the basis of a first digital representation of a histological slide that has been subjected to a staining step that causes the pixels of said first digital representation to become different colours depending on whether said pixels describe emptiness, tissue or muscle cells. Said method especially consists in identifying pixels describing at least one polygon of interest in digital representations created from the first digital representation, in discerning, per polygon of interest, a lumen, an intima and a media of a vessel, and in producing at least one morphometric measurement of said vessel. Such a method comprises a step of producing a morphometric quantity of interest for the organ on the basis of said morphometric measurements of the identified vessels.

The invention relates to a system and a method for morphometric analysis of blood vessels of a human or animal organ. Such an analysis is automatically performed from an image, or more generally from a digital representation, of a histological section of an organ, and provides an objective and reproducible aid to all healthcare personnel, so that they can establish an accurate diagnosis with reference to a possible human or animal pathology. Moreover, the invention provides that such an analysis can provide an objective and reproducible aid to an investigator in the laboratory, so that they can make a decision without ambiguity on the curative relevance of a given treatment with respect to such a pathology.

Medical imaging is currently one of the major resources for examining the different tissues and organs. In particular, it is predominantly involved in the fields of medical diagnosis support and preclinical and clinical research.

Different techniques are currently used in preclinical and clinical imaging, such as, non-limitatively, magnetic resonance imaging, optical, electron and confocal microscopy, microtomography, ultrasound scanning, CT scanning. These techniques can be implemented for in vivo or ex vivo observations. The digital images thus obtained make it possible, in the context of institutional or industrial research laboratories, more particularly to analyze the morphological and functional characteristics of the tissues and to assess the beneficial and/or toxic effects of certain substances with a view to selecting them for the development of future medicinal products.

In the era of digital transformation, the development of such digital imaging technologies has opened new perspectives for histological analysis as a whole. The ability to access digital matrix images or representations of histological sections has made it possible to develop new methods based on descriptive and quantitative analysis of the digital images of said histological sections, by means of computerized tools implementing algorithms or innovative procedures allowing a considerable advance in terms of precision, reliability, speed and reproducibility.

However, using the computerized tools that are currently available does not make it possible to automate the quantitative assessment of certain pathologies, such as, by way of non-limitative example, pulmonary disorders. In fact, the investigator still remains only too present in the process of implementing this assessment. As a result, their manual involvement leads to wide variations in the morphometric evaluation of the tissue components of the samples of histological sections assessed.

Within the framework of aid to the diagnosis of certain pathologies such as for example pulmonary hypertension, it would be particularly desirable to be able to accurately determine any morphological change or remodelling of the tissue. Pulmonary hypertension is a haemodynamic abnormality encompassing a set of pathologies defined in humans by elevated pressure in the pulmonary vessels. It is induced by the existence of multiple phenomena, alone or in combination to varying degrees. Such phenomena can consist of an increase in pulmonary blood flow, pulmonary venous hypertension, pulmonary vasoconstriction that is generally accompanied by significant vascular remodelling. Pulmonary hypertension has been defined in five clinical classes or groups as a function of its genesis, its pathological and haemodynamic characteristics and the treatment strategy: Group 1-Pulmonary arterial hypertension, also known by the abbreviation PAH; Group 2-pulmonary hypertension due to heart disease; Group 3-pulmonary hypertension due to respiratory disease and/or hypoxia; Group 4-chronic thromboembolic and obstructive pulmonary hypertension; Group 5-pulmonary hypertension caused by multifactorial mechanisms, some of which still remain unclear.

The usual symptoms of pulmonary hypertension include dry cough, vomiting, respiratory insufficiency, tiredness and vertigo, which are exacerbated by physical activity or exercise. Given that the pathogenesis of pulmonary hypertension is mainly irreversible, the disease often has a poor prognosis. The pulmonary arterioles are damaged, for example by the development of occlusive lesions and/or thickening of the arterial walls. Such processes result in a significant and sustained increase in pulmonary arterial pressure which thus leads to serious disorders such as right ventricle insufficiency.

All the forms of pulmonary hypertension display arterial morphological changes, comprising thickening of the vessel walls, the emergence of cells with the muscular phenotype in the vascular walls of small arteries or peripheral arteries. In particular, there is a fatal form of hypertension called pulmonary arterial hypertension (also known by the abbreviation PAH) characterized by a progressive increase in the pulmonary arterial pressure, resulting in right ventricular hypertrophy leading to right cardiac insufficiency. The remodelling undergone by the vessels, caused by hypertrophy or the cell proliferation of the smooth muscle of the pulmonary arterial media and/or by various processes revealed by a thickening of the arterial or venous intima, leads to occlusion of the lumen of the blood vessels. What mainly distinguishes pulmonary arterial hypertension from pulmonary hypertension is the severity of the arteriopathic attack, characterized with respect to anatomical pathology by the emergence of plexiform lesions. These lesions correspond to clusters of endothelial cells involved in an aberrant angiogenesis process similar to certain neoplastic phenomena. In clinical practice, diagnosis of this disease relies essentially on a functional assessment and a physical examination, which may be accompanied by an electrocardiogram, thoracic radiography, ultrasound cardiography, pulmonary scintigraphy. Surgical pulmonary biopsy is very rarely performed, as it is not risk-free.

With a view to extending the knowledge about pulmonary hypertension and in parallel with the research and development of therapeutic molecules, it is essential to establish a robust animal model. To date, several animal models of pulmonary hypertension have been established. Among the models originating with rodents, monocrotaline models of chronic hypoxia and lesions are those that have contributed most to the study of the pathophysiology of pulmonary hypertension. The “monocrotaline” model, developed in the rat, has the advantage of presenting severe pulmonary vascular lesions and right ventricle hypertrophy similar to those observed in patients. The chronic hypoxia model is more usually used in the mouse, but nevertheless presents lesions of lesser significance. Other models have emerged in the last few years, in particular with the model of rodents exposed to hypoxia associated with inhibition of the vascular endothelial growth factor receptor (VEGFR) by Sugen 5416 (SuHx). The latter model makes it possible to better investigate more particularly pulmonary arterial hypertension, as it reproduces the formation of plexiform lesions in addition to the changes to the right ventricle and pulmonary vessels. Genetically modified mouse models have also been developed for studying pulmonary hypertension, but have not made it possible to meet the anticipated expectations for the replication of the vascular and cardiac lesions described in patients.

The preclinical models are generally characterized by telemetry, in particular by recording the systolic pressure of the right ventricle, by ultrasound cardiography and histopathology analysis. Pulmonary hypertension is induced by a remodelling of the vascular layers. Histological analysis of the vascular remodelling is carried out equally well on the left, the right, or both lungs, from histological sections stained either with haematoxylin and eosin (H&E), or with Verhoeff-Van Gieson for staining the elastic membranes called lamina or also by immunohistochemistry using Von Willebrand factor (VWF), CD31 or CD34 for the specific staining of the endothelial cells. This analysis relies mainly on the optical microscopy images corresponding to various fields of observation of the histological section.

The vessels are generally categorized according to their type (veins, arteries or undefined) and/or their size determined from their external diameter. Quantitative analysis of the vascular remodelling, in particular in the case of pulmonary arterial hypertension, mainly includes measuring the thickness of the media and the occlusion of the lumen. When it is difficult to determine the type of vessels, in particular due to the difficulty in distinguishing the two lamina, the media is not measured or the intima and the media are combined and the measurements performed on the combination. There are several size classifications, based on anatomical criteria or on more empirical undefined criteria. Thus, the vessels having external diameters less than thirty micrometres are generally pre-capillaries, those having external diameters comprised between thirty and sixty micrometres are arteries of the alveolar channels or the respiratory bronchioles, and those having external diameters comprised between sixty and one hundred micrometres are arteries of the terminal bronchioles.

FIG. 1 depicts the anatomical structure of a cross section (more precisely a half cross section along an axis CC for the sake of simplicity) of a vessel V. It is noted that a vessel V is constituted by three layers or cell layers:
an inner tunica or intima I constituted mainly from inside to outside by a monolayer of endothelial cells delimiting the vascular lumen or lumen L and a thin layer of conjunctive tissue;
a median tunica or media M formed by smooth muscle cells and elastic material also known by the term “lamina elastica”;
an outer tunica or adventitia A constituted by a conjunctive tissue enclosing various cell components such as adipocytes, fibroblasts, and collagen.

With respect to the arteries, two membranes MEI and MEE of elastin fibres separate on the one hand, (MEI) the intima I from the media M, and on the other hand, (MEE) the media M from the adventitia A. These membranes MEI and MEE as well as the media M can with difficulty be distinguished on the veins.

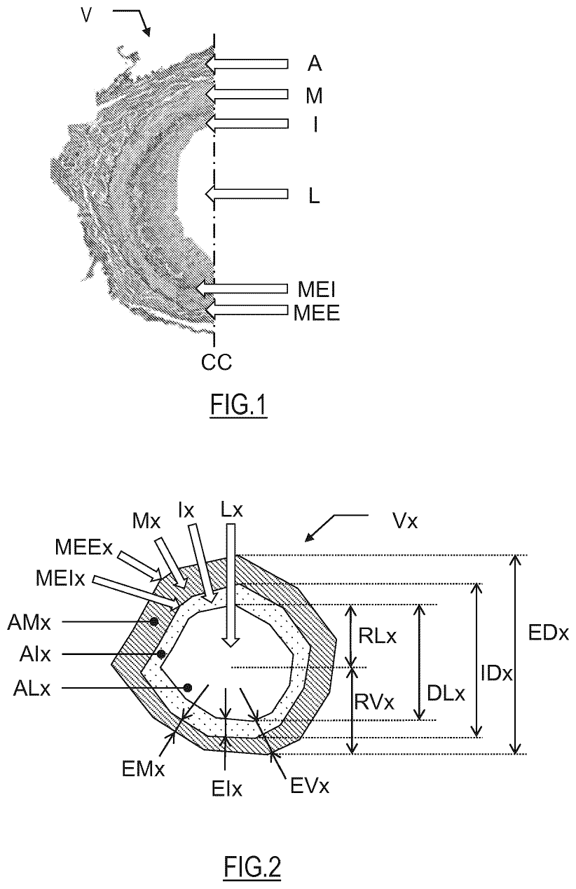

FIG. 2 depicts, in a simplified form, a cross section of an xth vessel, which is referenced Vx, from an organ such as a lung OG. FIG. 2 makes it possible to define parameters or morphometric measurements of such a vessel Vx, such as areas, radii or thicknesses of the intima Ix, of the media Mx and of the lumen LX of the vessel Vx. Thus, FIG. 2 depicts for the vessel Vx, the area ALx of the lumen Lx, the area ALx of the intima Ix, the area AMx of the media Mx, the diameter DLx or radius RLx of the lumen, the thickness EIx of the intima Ix, the thickness EMx of the media Mx, the external EDx and internal IDx diameters of the vessel Vx, said internal diameter IDx corresponding to the diameter of the inner lamina MEIx or also the diameter DLx of the lumen Lx depicted by the intima Ix of the vessel Vx.

A quantification of the thickness EMx of the muscle layer of said vessel Vx can be established from the difference between the external diameter EDx of the vascular wall (outer limit of the media Mx) and its internal diameter IDx (inner limit of the media Mx). The outer and inner limits of the media Mx are generally determined by the elastic membranes MEIx and MEEx revealed by the Verhoff Van Gieson stain, when this is possible. More rarely, the limits of the media Mx are determined from immunolabelling of the smooth muscle layer by alpha-smooth muscle actin (alpha-SMA). Quantification of the occlusion of the lumen can be performed from measurement of the thickness EVx of the vascular wall (intima Ix+media Mx) with respect to the total radius RVx of the vessel Vx.

Quantification of vascular remodelling currently makes use of various proprietary software programs developed by suppliers of optical microscopes or CT scanners or also from the ImageJ software (Image processing and Analysis in Java). With regard to analysis of a histological section of a lung by means of these image analysis software programs, it is necessary to undertake a prior manual selection of the pulmonary vessels within the histological section. As this action is manual, approximately thirty to forty vessels distributed over the section as a whole are thus generally selected. One to four measurements per vessel are then performed by means of a computer by one or two investigators in blind fashion. The elements measured are generally the following:
the thickness of the media EMx, expressed as micrometres or with respect to the radius RVx of a vessel Vx;
the absolute or relative quantity of vessels partially or completely obstructed, i.e. the lumen Lx of which is more than fifty percent obstructed.

These conventional methods developed for quantifying the remodelling of the pulmonary vessels have a certain number of limitations due in large part to the numerous manual procedures implemented. In fact, the vessels that are subjected to morphological measurements must be circular in shape to be selected, the ratio of their large external diameter with respect to their small external diameter must be less than two. As mentioned above, this time-consuming task of measurements thus concerns thirty to forty vessels per section. The measurements carried out at four points do not make it possible to take account of the irregularity of the structures. Moreover, the two lamina MEI and MEE of a vessel V must be assessed by the investigator in order to measure the thickness EM or the area AM of the media M, said measurement being manual. The intima I is rarely measured, despite evidencing the severity of an arteriopathy for example.

The invention makes it possible to overcome the drawbacks of the conventional measurements dependent on the investigator and provides invaluable and reliable aid to any investigator wishing to estimate quantities of interest with a view to generating an indicator facilitating the establishment of an accurate, reliable and reproducible diagnosis with reference to a human or animal pathology affecting the pulmonary tissue in particular, or of the relevance of a treatment with respect to said pathology.

Among the numerous advantages achieved by the invention, there may be mentioned more particularly those making it possible to:
considerably reduce the analysis time necessary for establishing a diagnosis of a pathology by an investigator, i.e. a few minutes depending on the processing power of the device or of the medical imaging system implementing a method according to the invention;
greatly increase the accuracy and reliability of the measurements of a sample analyzed, the latter being automatic, i.e. without human intervention, and concerning more than ten times more vessels than at present;
overcome intra- and inter-variability of the results between different investigators and laboratories, since objective and reproducible measurements are delivered;
quantify automatically, on the basis of the measurements of morphometric characteristics of the pulmonary vessels, the remodelling of the media and intima as well as the occlusion of the lumens of the pulmonary vessels without the need for a delimitation of the elastic layers;
dispense with a prior visual selection of the vessels, a time-consuming task that gives rise to errors;
contribute preliminary answers on the mechanisms in play during assessment of the efficacy of candidate drugs.

To this end, the invention provides firstly a method for generating a morphometric quantity of interest of a section of a human or animal organ, from a first digital representation of a histological section, said first digital representation consisting of a pixel table, each pixel encoding a set of integer values respectively describing luminous intensities of primary colours, said method being implemented by a processing unit of a medical imaging system, said system also including an output human-machine interface. In order to generate such a morphometric quantity that is accurate, reliable and takes account of the set of items of information available on the examined section of the organ, the histological section was subjected to a staining step, prior to its digitization, in order to generate said first digital representation, said staining causing distinct colourings of the pixels of said first digital representation when these latter depict a blank, tissue or muscle cells. Furthermore, said method includes:
a. a step of distinguishing the pixels of said first digital representation depicting tissue from those depicting a blank and forming a “parenchyma mask” in the form of a second digital representation having the same dimensions as the first digital representation, each pixel of which depicts:
   i. a first characteristic value when the corresponding pixel in the first digital representation depicts tissue;
   ii. a second characteristic value when said corresponding pixel in the first digital representation depicts a blank;
b. a step of distinguishing the pixels of said first digital representation depicting muscle cells and forming a “muscle cells mask” in the form of a third digital representation having the same dimensions as the first digital representation, each pixel of which depicts:
   i. a first characteristic value when the corresponding pixel in the first digital representation depicts a muscle cell
   ii. a second characteristic value otherwise;
c. an iterative step of analysis of the second and third digital representations consisting of:
   i. identifying the pixels depicting at least one polygon of interest within one of the second and third digital representations;
   ii. distinguishing, from said second and third digital representations and from the at least one identified polygon of interest, a lumen, an intima and a media of a vessel;
   iii. generating at least one morphometric measurement of said lumen, intima and/or media of said vessel and storing said at least one morphometric measurement in the data memory;
d. a step of generating a morphometric quantity of interest of the tissue of the human or animal organ from at least one morphometric measurement of a vessel stored in the data memory;
e. a step of causing an output of said morphometric quantity of interest via the output human-machine interface.

According to an advantageous embodiment, such a method can include a step of distinguishing the pixels of interest of said first digital representation and forming a “section mask” in the form of a fourth digital representation having the same dimensions as the first digital representation, each pixel of which depicts a first characteristic value when the corresponding pixel in the first digital representation depicts the section of the organ and a second characteristic value otherwise.

In this case, such a method can include a step, for each pixel not depicting the section of the organ, of assigning second respective characteristic values to the corresponding pixels of the second and third digital representations.

In order to ensure that only the vessels are identified as components of interest, a method according to the invention can include a step of confirmation or invalidation of the identification of a polygon of interest depicting a vessel, said at least one generated vessel morphometric measurement only being stored in the data memory if said step of confirmation or invalidation confirms the identification of a polygon of interest depicting a vessel.

According to this advantageous embodiment, such a method can include a prior step of staining the histological section moreover causing distinct colouring of the pixels depicting cell nuclei of the tissue. Said method can then include a step of distinguishing the pixels of said first digital representation depicting cell nuclei and forming a “nuclei mask” in the form of a fifth digital representation having the same dimensions as the first digital representation, each pixel of which depicts:
i. a first characteristic value when the corresponding pixel in the first digital representation depicts a cell nucleus;
ii. and a second characteristic value otherwise.

According to this embodiment, the step of confirmation or invalidation of the identification of a polygon of interest depicting a vessel can be arranged to use the muscle cells mask and said nuclei mask jointly.

In order ultimately to generate a morphometric quantity of the examined organ, the at least one morphometric measurement generated from the lumen, intima and/or media of an identified vessel can belong to a set including the area of the lumen, the area of the intima, the area of the media, the radius of the lumen, the thickness of the intima, the thickness of the media, the thickness of the vessel wall consisting of the sum of the thicknesses of the intima and the media, the respective thicknesses of the intima, the media, the vessel wall with respect to the total radius of the vessel consisting of the radius of the lumen to which are added the thicknesses of the intima and the media, said total radius of the vessel, a ratio of obstruction of said vessel.

Advantageously and non-limitatively, a quantity of interest generated by a method according to the invention can consist of calculating a mean value of at least one morphometric measurement from a plurality of vessels, calculating such a mean value normalized by the area of the examined section, or even normalized by a determined number of vessels present in said section.

A method according to the invention can generate a quantity of interest additional to that concerning the vascularization per se of the organ. Such an additional quantity can reveal the presence of pathological lesions and be used for example to better understand the severity of a pathology, for example such as pulmonary arterial hypertension. To this end, such a method can include an iterative step of joint analysis of the second and third digital representations consisting of:
identifying the pixels depicting one or more tissue structures of interest in the form of at least one lesion polygon;
generating at least one morphometric measurement of each identified lesion polygon;
confirming or invalidating the identification of a structure of interest as a pathological lesion from said at least one morphometric measurement of each identified lesion polygon;
incrementing by one unit the value of a counter of pathological lesions when the identification of a structure of interest as pathological lesion is confirmed;
generating an additional morphometric quantity of interest from the value of said counter of pathological lesions.

According to this advantageous embodiment, the step of generating a morphometric quantity of interest from the tissue of the human or animal organ can use jointly said additional morphometric quantity of interest and the morphometric measurements of the identified vessels.

When the method provides for constituting a nuclei mask, the step of generating at least one morphometric measurement of each identified lesion polygon can consist of adding polygons present in the mask of nuclei that are circumscribed by said lesion polygon.

In order to make the implementation of such a method possible, the step of staining the histological section causing distinct colourings of the blank, of the tissue, and of the muscle cells, can consist of jointly performing a colouring with haematoxylin and immuno-histochemistry staining the alpha-smooth muscle actin protein using a chromogen.

According to a second subject, the invention relates to a computer program product including one or more program instructions that can be interpreted by the processing unit of an electronic object, said program instructions being capable of being loaded into a non-volatile memory of said electronic object and the execution of which by said processing unit causes the implementation of a method according to the first subject of the invention.

The invention also relates to an item of computer-readable memory media containing the instructions of such a computer program product.

Moreover, the invention relates to an electronic object including a processing unit, a data memory, a program memory, an output human-machine interface, when said program memory contains the program instructions of a computer program product according to the invention.

Other characteristics and advantages will become more clearly apparent on reading the following description and on examining the figures accompanying it, in which:

FIG. 1, already described, a sectional view of a vessel of a human or animal organ;

FIG. 2, already described, shows morphometric parameters of interest from a simplified and stylized description of the section of such a vessel;

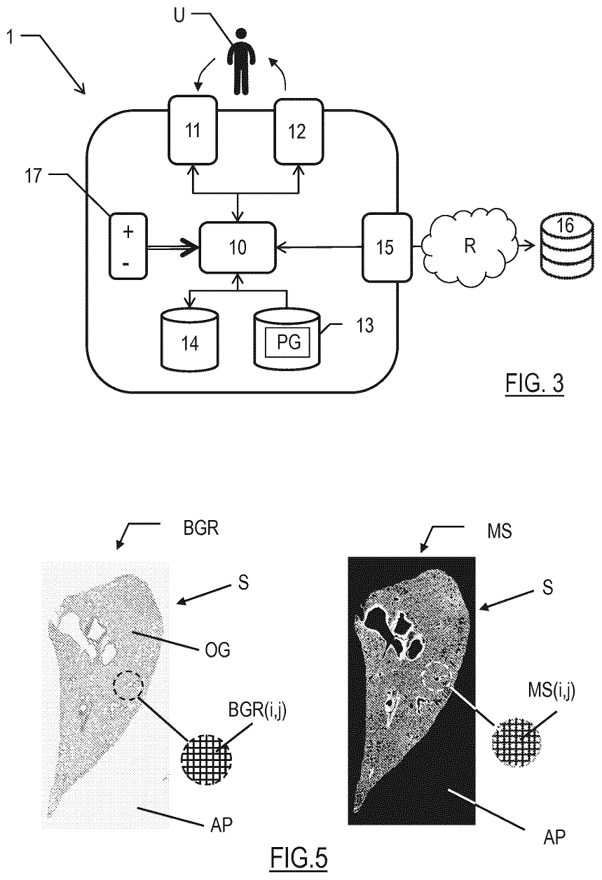

FIG. 3 shows an example of an electronic object or of a medical imaging system arranged to implement a method for morphometric analysis of a vascularized human or animal organ according to the invention;

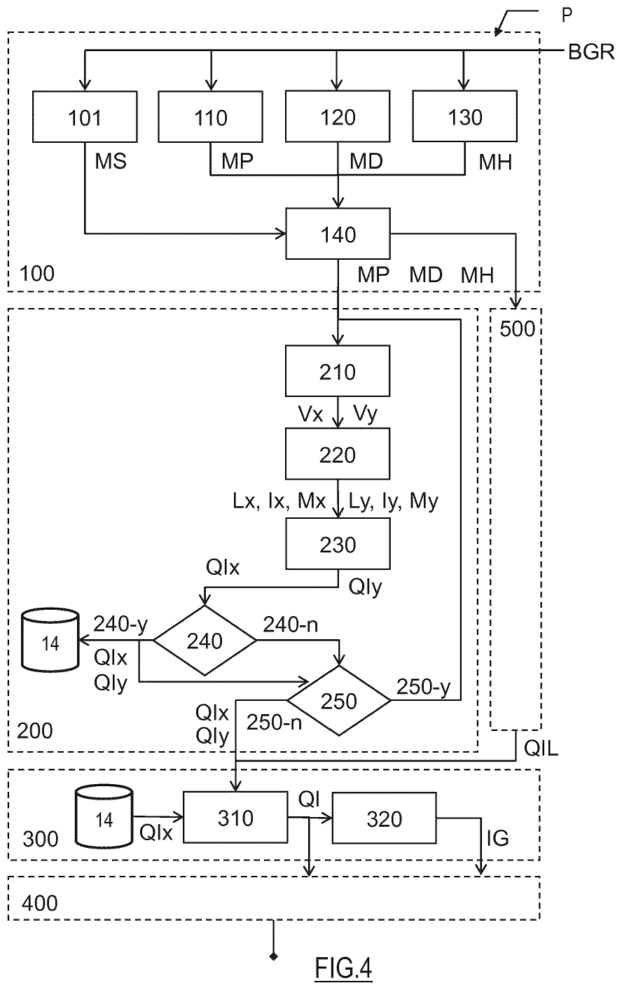

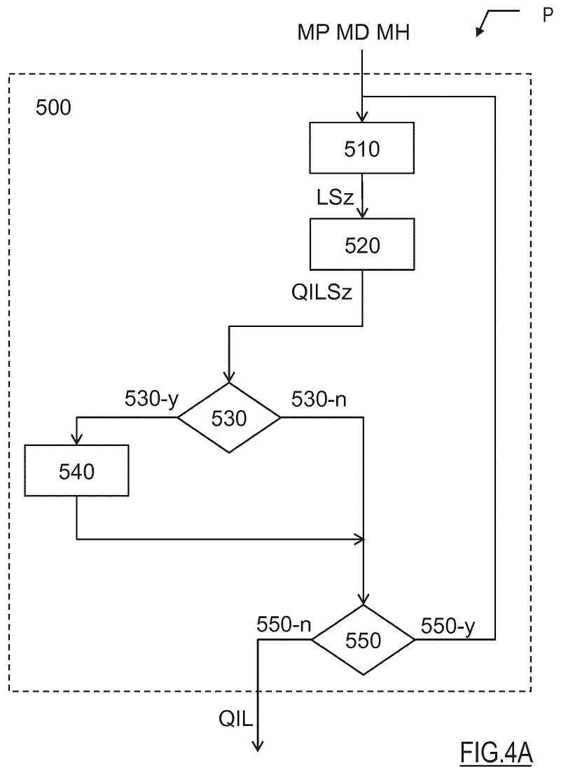

FIG. 4 shows an example of a functional algorithm of a method for morphometric analysis of a vascularized human or animal organ according to the invention;

FIG. 4A shows an example of a functional algorithm of a processing additional to the morphometric analysis of a vascularized human or animal organ according to the invention;

FIG. 5 shows two digital representations, in the form of a colour image and a binary image taken therefrom, of a section of a pulmonary lobe;

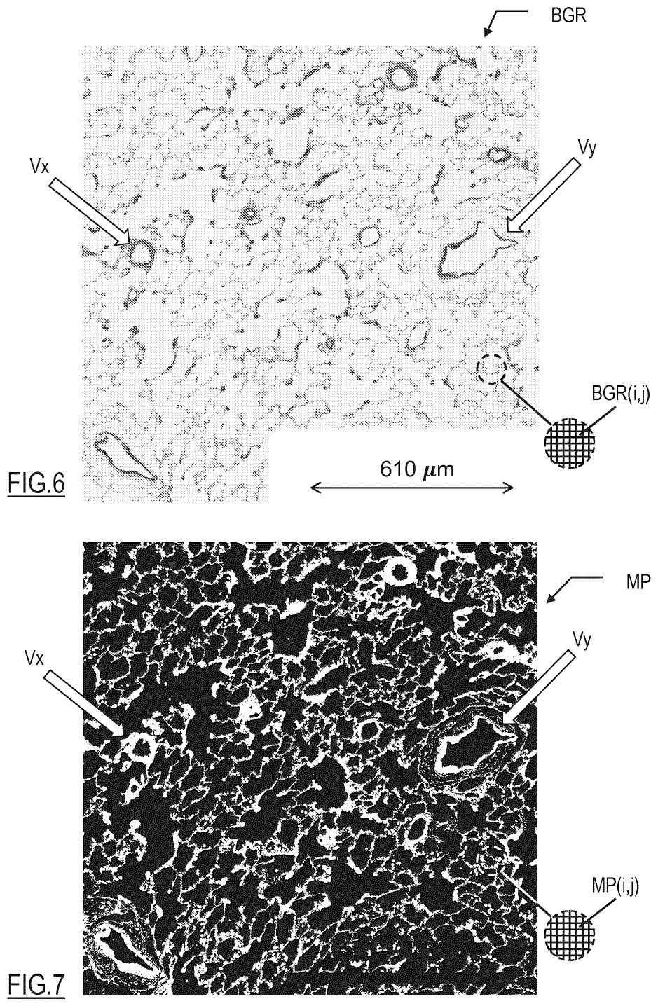

FIG. 6 illustrates a partial enlargement of a colour image depicting said section of a pulmonary lobe;

FIG. 7 shows an example parenchyma mask of a section of a pulmonary lobe generated according to the invention;

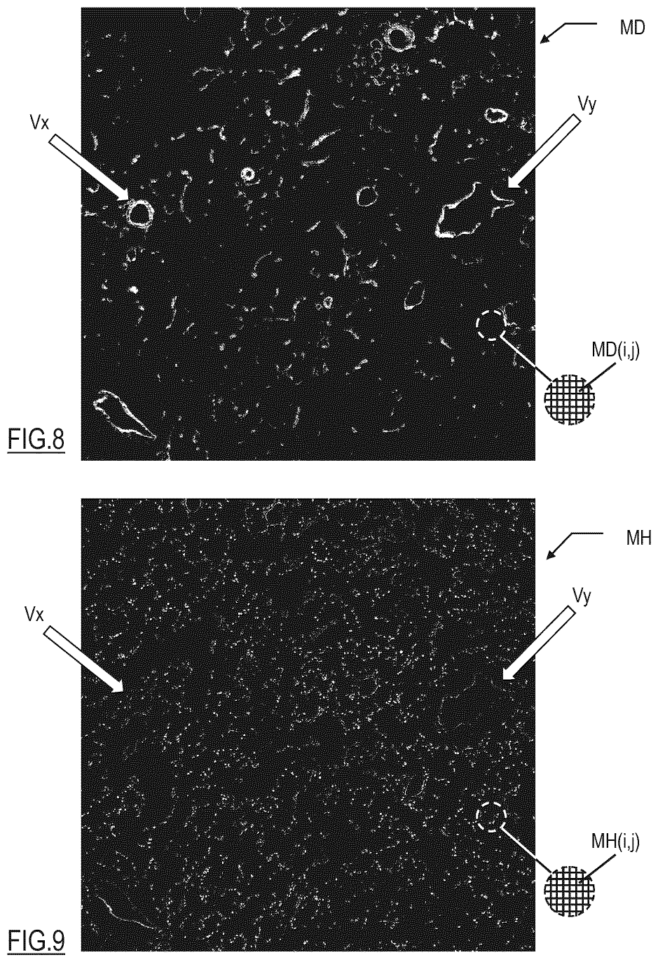

FIG. 8 shows an example mask of the muscle cells of a section of a pulmonary lobe generated according to the invention;

FIG. 9 shows an example mask of the cell nuclei of a section of a pulmonary lobe generated according to the invention;

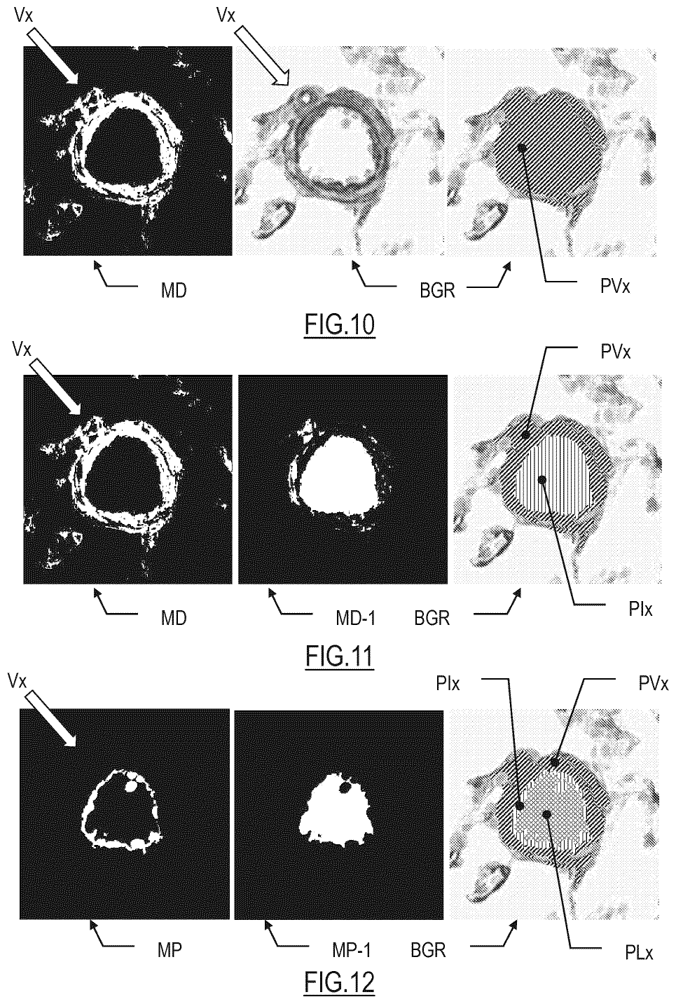

FIG. 10 illustrates the implementation of a first embodiment according to the invention for identifying a vessel from a muscle cells mask;

FIG. 11 illustrates the implementation of a step of a first embodiment according to the invention for determining the lumen, the intima and the media of a vessel;

FIG. 12 illustrates the implementation of a second step of a first embodiment according to the invention for determining the lumen, the intima and the media of a vessel;

FIG. 13 illustrates the implementation of a second embodiment according to the invention for identifying a vessel from a parenchyma mask;

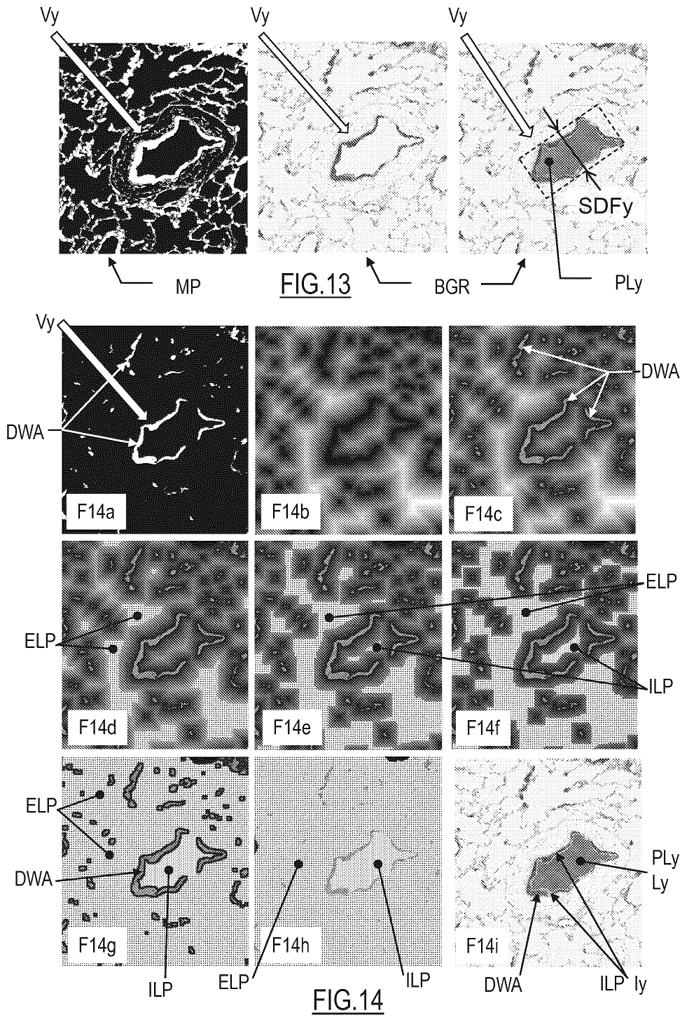

FIG. 14 illustrates the implementation of a step of a second embodiment according to the invention for determining the lumen, the intima and the media of a vessel;

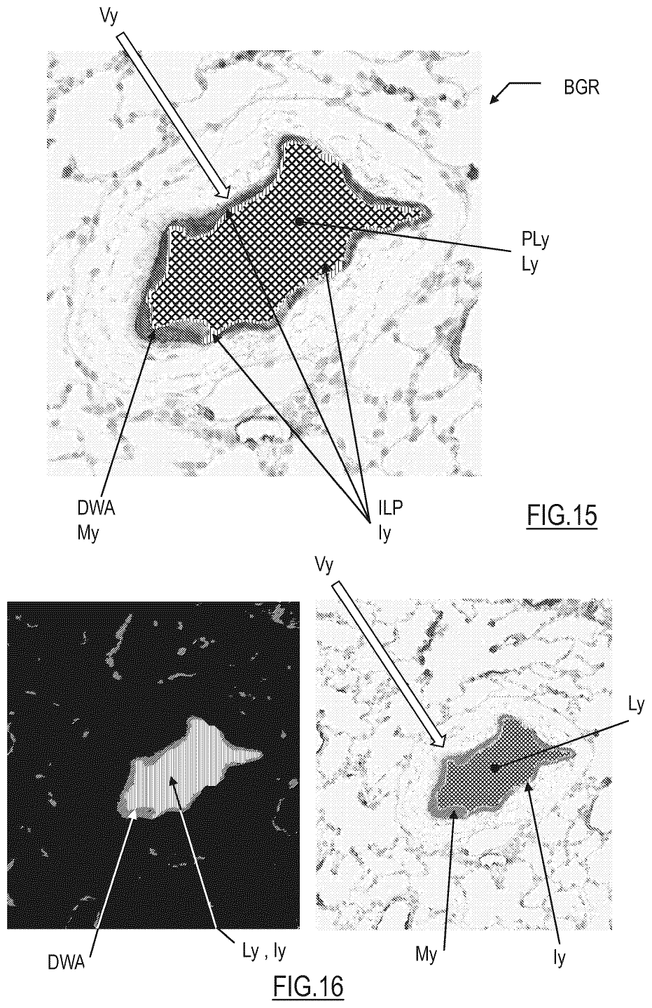

FIG. 15 illustrates the result of such a step illustrated by FIG. 14;

FIG. 16 illustrates the implementation of a second step of a second embodiment according to the invention for determining the lumen, the intima and the media of a vessel;

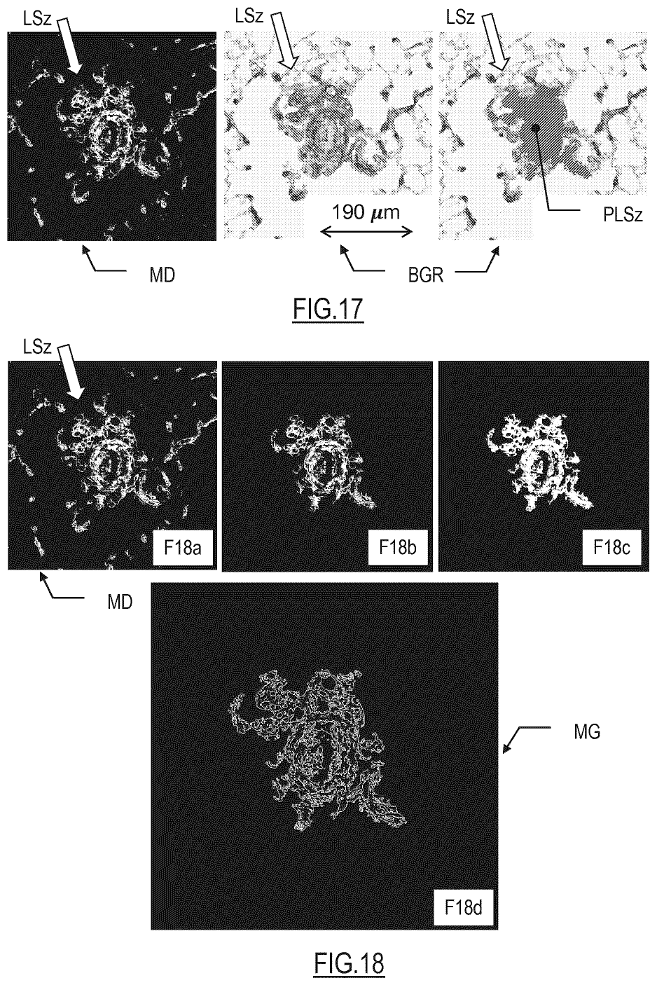

FIG. 17 illustrates the implementation of an embodiment according to the invention for identifying a lesion polygon from the muscle cells mask;

FIGS. 18 to 21 each illustrate the implementation of a step of producing a morphometric measurement of an identified lesion polygon.

FIG. 5 depicts a first digital representation BGR of a histological section S of a rat lung. FIG. 6 presents a partial enlargement of such a digital representation BGR. The latter has generally originated from a process or a prior step of digitization of a histological section S. According to the example in FIG. 5, a digitized histological section with an enlargement ratio of twenty (x20) thus delivers said first digital representation BGR in the form of an array with approximately two hundred million pixels BGR(i,j), i and j being indices of integer values for identifying the pixel situated at the i^{th} row and j^{th} column of the array BGR, i.e. according to the example in FIG. 5, a representation in the form of a table or array of fifteen thousand rows to the same number of columns, each element BGR(i,j) of said table BGR encoding a triplet of integer values comprised between zero and two hundred and fifty-five, according to the RGB (red green blue) colour coding. Such a computerized colour coding is the most compatible with the currently available hardware for constituting output human-machine interfaces such as computer screens. In general, these latter reconstitute a colour by additive mixing from three primary colours, red, green and blue, forming on the screen a mosaic that is generally too small to be distinguished by a human eye. The RGB coding gives a luminous intensity value for each of these primary colours. Such a value is generally encoded on one byte and thus belongs to an integer value interval comprised between zero and two hundred and fifty-five. In a variant, it is possible for other colour codings to be used. In this case, each pixel or element of the table BGR would depict a set of numerical values suitable for said coding instead of the triplet mentioned above for the RGB coding.

The representation BGR shows the parenchyma or tissue of a lung composed of numerous tubular components including vessels, bronchi, bronchioli or also alveoli forming alveolar sacs. The inner walls of said components respectively form lumina or lumens. Following the sectioning performed at the level of the pulmonary lobe, sections of said components are visible in two dimensions, with substantially annular shapes. On the enlargement depicted in FIG. 6, two components, in this case two vessels Vx and Vy are referenced and have annular shapes as described above in connection with FIGS. 1 and 2.

Certain pathologies including pulmonary hypertension induce remodelling of the tissue forming the vessels of the pulmonary lobe. In order to characterize such a remodelling, it is necessary to assess or measure morphometric parameters or characteristics of said vessels, in particular the media, intima and lumens thereof. The first digital representation BGR of the histological section S illustrated by FIGS. 5 and 6 represents a histological section S stained beforehand using a technique from immunohistochemistry (known by the abbreviation IHC) labelling the alpha-smooth muscle actin protein (known by the abbreviation alpha-SMA), using an antibody and staining agent, such as diaminobenzidine (known by the acronym DAB), or any other chromogen, and a counterstain of the tissue, in this case haematoxylin (known by the abbreviation H). The digital representation BGR thus depicts the blank, or the histological section background in white, the muscle cells in brown and the other cells constituting the parenchyma in grey-blue, more specifically the nuclei of said cells in blue, the rest of the tissue appearing in grey by diffusion of the stain. It is noted that a first vessel Vx, referenced by the digital representation BGR in FIG. 6, depicts a polygon, i.e. a surface area delimited by an almost circular closed polyline, brown in colour. A second vessel Vy shows, in FIG. 6, an oblong cross section the contour polyline of which appears to be incompletely closed, certain segments not being visualized. It will become apparent according to different embodiments of the invention how to capture a maximum of vessels despite the sections thereof not appearing clearly polygonal on the digital representation BGR.

Other types of staining are nevertheless also envisaged in the context of the invention provided that such a preparation (staining) causes distinctive or distinct colourings of the pixels of said digital representation BGR when these latter depict a blank, tissue, muscle cells, or cell nuclei of said parenchyma. There may be mentioned in particular immunolabelling using Von Willebrand factor, CD31 or CD34 or Verhoeff-Van Gieson stain.

The invention consists of offering a particularly valuable aid to healthcare personnel responsible for estimating a degree of pathology of a patient's lung. Unlike the current techniques according to which certain zones of the section are examined manually by an analyst, the invention provides for the implementation of a method, such as the method P depicted by way of preferred but non-limitative example in FIG. 4, designed for automatically analyzing the entirety of the information contained in said histological section S.

Such a method P is materialized in the form of a computer program product PG the program instructions of which are intended to be installed in the program memory of a medical imaging system, for example a computer or a computer server, or more generally, any electronic object having a sufficient computation power and/or capable of analysis of digital representations or images of appropriate sizes, taking account of the precision necessary for analysis of a histological section.

As indicated in FIG. 3, such an electronic object 1 includes, as well as a program memory 13, a processing unit 10 in the form of one or more microcontrollers or microprocessors. These latter cooperate in particular with a data memory 14 storing digital representations of a histological section S produced by the implementation of a computer program PG according to the invention, or even by other third-party techniques, as well as operating parameters and any other data generated, whether they consist of intermediate data or results relating to a remodelling of tissues, a simple consultation of which informs healthcare personnel in reaching a diagnosis.

By “data or program memory” 13 and 14 is meant any volatile, or advantageously non-volatile, computer memory. A non-volatile memory is a computer memory the technology of which makes it possible to retain its data in the absence of an electrical power supply. It can contain data resulting from inputs, calculations, measurements and/or program instructions. The main non-volatile memories currently available are of the type that can be written to electrically, such as EPROM (“erasable programmable read-only memory”), or written to and erased electrically, such as EEPROM (“electrically-erasable programmable read-only memory”), flash, SSD (“solid-state drive”), etc. The non-volatile memories are distinguished from the memories known as “volatile”, the data of which are lost in the absence of an electrical power supply. The main volatile memories currently available are of the type RAM (“random access memory”, also known as “read-write memory”), DRAM (dynamic random access memory, requiring a regular refresh), SRAM (static random access memory, requiring such a refresh when there is an insufficient electrical power supply), DPRAM or VRAM (both particularly suitable for video), etc. In the remainder of the document, a “data memory” can be volatile or non-volatile according to the intended application.

Such an electronic object 1 includes, or cooperates with, an output human-machine interface 12, such that said processing unit 10 can cause the output of graphic results, when said output human-machine interface 12 consists, according to non-limitative examples, of one or more computer screens or any printing peripheral. More generally, throughout the document, by “output human-machine interface” is meant any device, used on its own or in combination, making it possible to output or deliver a graphic, haptic or sound representation, or one which is more generally perceptible to the human U, of a quantitative, physiological or informative data item. Such an output human-machine interface 12 can consist, non-limitatively, of one or more screens, loudspeakers or other suitable alternative means.

Such an electronic object 1 can also include an input human-machine interface 11 making it possible for a user U to transmit input data, orally, by touch, even gesturally, to parameterize the operation of said electronic object 1. Such an input human-machine interface 11 can consist for example of a computer keyboard, a pointer device, a touch screen, a microphone or, more generally, any human-machine interface arranged to translate a gesture or an instruction issued by a human U into control or parameterization data. Such an electronic object 1 can also include communication means 15, making it possible, by wired or contactless means R, for it to communicate with a remote electronic object 16, such as a computer server for hosting, sharing digital representations of histological sections or any other digital items of information of interest. The link R can thus comprise a communication via intranet, extranet or internet. The concept of electronic object 1 can thus be extended to the concept of medical imaging system 1 to cover the set of possible hardware configurations. Finally, such an object or medical imaging system 1 can include means 17 for delivering the electrical energy necessary for its operation, such as one or more batteries in order to allow a form of remote working or a connector to the electricity supply network.

As indicated in FIG. 4, a method P according to the invention proposes to quantify one or more morphometric quantities QI revealing any possible remodelling of the vessels of a vascularized organ such as, by way of preferred but non-limitative example, a pulmonary lobe. When a plurality of quantities of interest QI are generated or a morphometric quantity QI is expressed in the plural, the invention provides for the latter to be expressed or translated as a multiparametric indicator IG including different components, communicated to a user U under different representations, in particular graphical representations.

Among the morphometric measurements of interest QIx pertaining to a vessel Vx supplying the section of an organ, such as a pulmonary lobe, there may be mentioned non-limitatively, with reference to FIG. 2:
the thickness EIx of the intima Ix expressed in micrometres;
the thickness EIx of the intima Ix with respect to the total radius RVx=EDx/2 of the vessel;
the area AIx of the intima Ix with respect to the total area of the section;
the thickness EMx of the media Mx, expressed in micrometres;
the thickness EMx of the media Mx with respect to the total radius RVx of the vessel;
the area AMx of the media Mx with respect to the total area of the section;
the thickness EVx=EIx+EMx of the vascular wall (intima+media) expressed in micrometres;
the thickness EVx of the vascular wall with respect to the total radius of the vessel RVx;
the area of the vascular wall (AMx+AIx) with respect to the total area of the section;
the number of vessels identified per unit of surface area (for example for a square millimetre);
the radius RLx or the diameter DLx of the lumen Lx;
the radius or the diameter IDx of the intima Ix;
the radius or the diameter EDx of the media Mx.

All or part of these morphometric measurements QIx can be expressed per identified vessel Vx or state mean QI values for the set of identified vessels, or also mean values by categories of vessels according to their overall radii (lumen, intima, media) or according to any other criterion. Other morphometric measurements QIx of interest could also be produced as soon as it becomes possible automatically to distinguish the lumen, intima and media of any identifiable vessel in the examined section.

A method P according to the invention can be described, as suggested in the embodiment example in FIG. 4, as including four main processings or steps, respectively referenced 100, 200, 300 and 400. It can also include an optional processing 500 for characterizing an emergence of plexiform lesions intended to complement a morphometric analysis of the vascularization of an organ, when the latter is a lung or, more generally, to characterize an emergence of complex hypercellular lesions for other organs.

A first processing 100 consists of generating, from a first digital representation BGR of the section of the organ in question via a histological section (prepared according to a colouring or staining technique such as the immunohistochemistry technique staining the alpha-SMA protein using a chromogen, in this case diaminobenzidine DAB, counterstained with haematoxylin or equivalent), second digital representations, having the same dimensions as said first digital representation BGR, in order to depict in particular, respectively, the parenchyma, the muscle cells, or the cell nuclei of the section of the organ from which the first digital representation BGR originates. The first processing 100 thus consists of generating new digital representations MS, MP, MD, MH, derived from the first representation or image BGR of the histological section, digital representations that will hereinafter be called “section mask” MS, “parenchyma mask” MP, “muscle cells mask” MD and “nuclei mask” MH. Generating the nuclei mask MH can be optional, despite advantageously making it possible to confirm or invalidate the identification of a component of interest as a vessel according to the embodiment retained for determining the vessel layers.

A second main processing or step 200 consists of using jointly said second digital representations generated in step 100 for identifying the components of interest of the section, in this case the vessels supplying the section of the pulmonary lobe. In iterative fashion, for each identified vessel Vx, said processing 200 consists of measuring the lumen Lx, the intima Ix and the media Mx and generating one or more morphometric measurements QIx of said vessel Vx as described above.

A third main processing or step 300 consists of consolidating, aggregating or using jointly morphometric measurements QIx generated in 200 in order to constitute one or more morphometric quantities QI of the examined tissue, for example in the form of mean values normalized by the area of the examined section. In a variant or in addition, such a morphometric quantity QI can consist of calculating a number of identified vessels, optionally quantified per unit of surface area of the section. In a variant or in addition, such a morphometric quantity QI can consist of a calculation using morphometric measurements QIx generated in 200, for example, to generate mean values normalized by a total number of vessels. Such a number of vessels can originate from the identification of these latter by the implementation of a processing 200 according to the invention and/or be obtained by the implementation of a step of analysis of a second histological section of a series from the same organ, for example stained by immunohistochemistry using Von Willebrand factor, CD31 or CD34, counting the set of vessels of the section examined, whether these latter are muscularized or not. In the latter case, it is reasonable to consider that the number of identified vessels from the second histological section describes the number of vessels present in the section S of the analyzed organ. Such quantity or quantities of interest QI can be jointly used in their turn to constitute a graphic indicator IG in order to facilitate reading the results of the analysis of the histological section by a professional. Such an indicator IG can consist of the concomitant presentation of several quantities QI or components thereof, in the form of a Kiviat graph (also known as a radar chart), histograms, curves, segment charts, etc.

Finally, a method P according to the invention includes a fourth step or main processing 400 consisting of causing an output of the quantity QI, or of the graphical indicator IG that can originate therefrom, by an output human-machine interface 12 of the medical imaging system 1 implementing such a method P, such as that described with reference to FIG. 3.

The first processing 100 of such a method P according to the invention will now be described with reference to FIGS. 4 to 9.

In order to allow the identification of vessels within a digital representation BGR, as illustrated in FIG. 5, regardless of the prior staining step of the histological section, a method P can advantageously include a step 101 consisting of a processing to “binarize” said first digital representation BGR and to generate a new digital representation MS, with the same dimensions as those of the first digital representation BGR, but for which each pixel MS(i,j) of said new digital representation MS, referenced by integer indices i and j, comprises a first predetermined value, for example “two hundred and fifty-five” to translate the Boolean value “true”, when the pixel BGR(i,j), having the same indices i and j within the digital representation BGR, consists of a pixel of interest, and a second predetermined value, for example “zero” to translate the Boolean value “false” otherwise. Such a new digital representation MS, which can be called “section mask” can be generated by any known type of digital processing intended to binarize a digital representation in colour(s), such as the digital representation BGR. As indicated in FIG. 5, depicting on the one hand a first digital representation BGR of a section S of an organ OG and on the other hand such a section mask MS associated therewith, the latter is translated in the form of a table including one and the same number of elements or pixels as the first digital representation BGR of a histological section from which it originates. Said section mask MS is called “binary” because each of its elements MS(i,j), denoted by two indices or indicators i and j, respectively determining the row and the column of said element or pixel in said mask, includes an integer value chosen from two predetermined values respectively signifying that the pixel BGR(i,j), i.e. from one and the same column j and one and the same row i in the first digital representation BGR, denotes a portion of interest of the organ or not. Such a generation of a section mask can be performed, according to a preferred but non-limitative embodiment, by establishing the greatest contour by implementing, for example, an algorithm such as a “flood-fill” algorithm, also known by the French name “algorithme par remplissage par diffusion”. By using, preferably but non-limitatively, first and second Boolean values “true” and “false”, it is then possible to carry out a simple logical multiplication, by said mask value, in order to take into account, or not, a pixel within a digital representation, having the same dimensions, originating from the first digital representation BGR. Thus, any pixel representing the exterior AP of the tissue of the organ OG present in the histological section S, or any other pixel captured by the perimeter of said tissue but depicting the lumen of a vein or of an artery for example, will not be considered pixels of interest, as will be described hereinafter. The invention should not be regarded as limited to the use of said values zero and two hundred and fifty-five. In a variant, other predetermined values could have been chosen to characterize the absence of interest or the interest of such a pixel. Moreover, reliance on the generation and use of such a section mask does not constitute an obligation and consequently a limitation for implementing the invention.

A processing 100 also includes a step 110 of distinguishing the pixels BGR(i,j) of said first digital representation BGR depicting the parenchyma of the examined section. In other words, the purpose of such a step 110 consists of forming a “parenchyma mask” MP in the form of a new digital representation, having the same dimensions as the first digital representation BGR, each pixel or element MP(i,j) of which depicts a first characteristic value when the corresponding pixel BGR(i,j) in the first digital representation BGR does not depict a blank or the background of the histological section (i.e. depicts tissue) and a second characteristic value otherwise. Such a parenchyma mask MP is a binary array representation. Said first characteristic value translates the Boolean value “true” and said second characteristic value translates the Boolean value “false”. FIG. 7 is an example parenchyma mask MP in the form of a black and white image according to which each pixel depicts an integer value equal to zero or two hundred and fifty-five to translate a minimum (black) or maximum (white) luminous intensity. According to this example the pixels adopt the value “0” to describe the Boolean information “false” and the value “255” to describe the Boolean information “true”. As a result the tissue marked by the prior step of staining the histological section appears in white, and the unstained tissue or a blank, in black. In order to obtain such a parenchyma mask MP, the step 110 can consist of thresholding the first digital representation BGR taking account of the different channels thereof. According to the example described with reference to FIG. 6 for which the RGB coding was retained to generate the image BGR, three channels are to be considered, with reference to the three primary colours, red, green and blue. Thus, a predetermined threshold, for example equal to 95% or 100% can be applied to each fraction of the estimation of the background colour, in this case substantially white. If the value of each channel is greater than said predetermined threshold, the pixel BGR(i,j) is considered as depicting the background or a blank. The corresponding pixel MP(i,j) adopts the characteristic value describing the Boolean value “false”. Conversely, if the value of at least one of the three channels is less than said predetermined threshold, said pixel BGR(i,j) is considered as depicting tissue. The corresponding pixel MP(i,j) adopts the characteristic value translating the value “true” in the parenchyma mask MP. The image shown with reference to FIG. 7 is as it were the image BGR shown in FIG. 6 after a step of “binarization” thereof.

A step 120 of a processing 100 of a method P according to the invention consists of generating, from said first digital representation BGR, a new digital representation with the same dimensions (i.e. having the same numbers of rows and columns of pixels) in the form of a muscle cells mask MD. In fact, the cells of the histological section expressing the alpha-SMA protein marked by the DAB in contact with an intima of a vessel constitute the media thereof. Such a step 120 consists of distinguishing the pixels of the first digital representation BGR expressing a brown colour (or dark grey in FIG. 6). According to the technique retained for preparing the histological section before its digitization, it is possible that some non-muscle cells are stained, jointly with the muscle cells per se and in an undifferentiated manner, by one and the same specific colour distinguishing them despite everything from the blank and from the tissue, in this case according to this example, the colour brown. When they cannot be distinguished more finely, these cells, whether muscle cells or not, jointly stained one and the same particular colour, will be integrated, within the meaning of the invention, with “muscle cells”. Distinguishing between the pixels BGR(i,j) depicting such muscle cells and the rest of the tissue is generally non-trivial. It is sometimes necessary, by way of non-limitative example, to implement a deconvolution operation of the values of said pixels in order to optimize said distinguishing of the pixels depicting muscle cells from those depicting the rest of the pulmonary tissue in this case. Such a segmentation by deconvolution 120 makes it possible to extract the main components of the first digital representation BGR, so as to maximize the differences of signal between the parts of the image showing different colours. Such a segmentation can make use, for example, of the singular value decomposition technique, also known by the abbreviation SVD. Such a technique relies on the fact that any array A, with coefficients originating from a field K, having real or complex numbers, of dimensions m by n, m and n being two non-zero integers, allows a decomposition such that A=UΣV* where V is a set of vectors of orthonormal basis Kn, called input vectors, U is a set of vectors of orthonormal basis Km, and Σ is the diagonal array, of dimensions m by n, the diagonal coefficients of which are the singular values of the array A, i.e. the eigenvalues of the array A*A. The objective of this decomposition is the calculation of the projection of the array A on one of the singular vectors, one of these directions making it possible to better separate the signal of the muscle cells (in this case, brown) from the rest of the tissue (in this case, grey-blue). Depending on the staining of the histological section retained, the first digital representation BGR can if necessary be converted into a second colorimetric space, such as the space CMY (abbreviation for cyan, magenta, yellow) so as to improve the segmentation process. In this case, the RGB space is pertinent for distinguishing the pixels depicting the muscle cells of the digital representation BGR according to FIG. 6.

The values of said first digital representation BGR, the latter being a pixel array, can be translated as optical densities, hereinafter stated with the abbreviation OD (for optical density) such as for three channels B (blue), G (green) and R (red):

$${OD}_{B} = - ln ( \frac{B}{255} ) ; {OD}_{G} = - ln ( \frac{G}{255} ) ; {OD}_{R} = - ln ( \frac{R}{255} )$$

each component B, G and R being encoded on one byte.

The channel of the projection that is the most promising for the segmentation of the muscle cells for the brown staining is then selected, for example the channel G. The latter is again expressed as an integer value comprised between 0 and 255 by application of the relationship:

$$G = 255 \cdot {e}^{- O {D}_{G}}$$

The step 120 can thus consist of generating a digital representation, having the same dimensions as the first digital representation BGR, the pixels of which thus encode a luminous intensity, such as an image in greyscale, the value of which is generated as described above.

Said step 120 can also consist of applying a thresholding filter, for example by using a threshold value equal to thirty-eight, of the respective values of said pixels to generate the muscle cells mask MD, in the form of a binary digital representation, having the same dimensions as the first digital representation BGR, the elements or pixels MD(i,j) of which encode a first predetermined value, for example equal to two hundred and fifty-five, when the corresponding pixels BGR(i,j) depict such muscle cells (translating the Boolean value “true”) and a second predetermined value, for example equal to zero, (translating the Boolean value “false”) otherwise. FIG. 8 depicts such an image MD corresponding to the same partial enlargement of the first digital representation BGR in FIG. 6. The muscle cells appear in white as opposed to the rest, which appears in black in the muscle cells mask MD.

The processing 100 of a method P according to the invention can also include a step 130 similar to the step 120 described above to constitute a new digital representation of the section of the analyzed organ in the form of a “nuclei mask” MH. Such a step 130 thus consists of generating, from said first digital representation BGR, a new digital representation with the same dimensions, i.e. having the same numbers of rows and columns of pixels. In fact, under the effect of the counterstaining with haematoxylin the cell nuclei of the histological section appear in blue. Such a step 130 consists of distinguishing the pixels of the first digital representation BGR expressing such a colour (light grey in FIG. 6). Distinguishing between the pixels BGR(i,j) depicting such cell nuclei and the rest of the tissue is generally non-trivial. It is sometimes necessary, by way of non-limitative example, as in step 120, to implement a deconvolution operation of the values of said pixels in order to optimize said distinguishing of the pixels depicting cell nuclei from those depicting the rest of the pulmonary tissue in this case. Such a segmentation by deconvolution 130 makes it possible to extract the main components of the first digital representation BGR, so as to maximize the differences of signal between the parts of the image showing different colours. Such a segmentation can make use, for example, of the singular value decomposition technique mentioned above. Depending on the staining of the histological section retained, the first digital representation BGR can if necessary be converted into a second colorimetric space, such as the space CMY (abbreviation for cyan, magenta, yellow) so as to improve the segmentation process. In this case, the RGB space is pertinent for distinguishing the pixels depicting the cell nuclei of the digital representation BGR according to FIG. 6.

The values of said first digital representation BGR, the latter being a pixel array, can be translated as optical densities, hereinafter stated with the abbreviation OD (for optical density) such as for three channels B (blue), G (green) and R (red):

$${OD}_{B} = - ln ( \frac{B}{255} ) ; {OD}_{G} = - ln ( \frac{G}{255} ) ; {OD}_{R} = - ln ( \frac{R}{255} )$$

each component B, G and R being encoded on one byte.

The channel of the projection that is the most promising for the segmentation of the cell nuclei for the grey-blue staining is then selected, for example the channel B. The latter is again expressed as an integer value comprised between 0 and 255 by application of the relationship:

$$B = 255 \cdot {e}^{- O {D}_{B}}$$

The step 130 can thus consist of generating a digital representation, having the same dimensions as the first digital representation BGR, the pixels of which thus encode a luminous intensity, such as an image in greyscale, the value of which is generated as described above.

Said step 130 can also consist of applying a thresholding filter, for example by using a threshold value equal to fifty, of the respective values of said pixels to generate the nuclei mask MH, in the form of a binary digital representation, having the same dimensions as the first digital representation BGR, the elements or pixels MH(i,j) of which encode a first predetermined value, for example equal to two hundred and fifty-five, (translating the Boolean value “true”) when the corresponding pixels BGR(i,j) depict such cell nuclei and a second predetermined value, for example equal to zero, (translating the Boolean value “false”) otherwise. FIG. 9 depicts such an image MH corresponding to the same partial enlargement of the first digital representation BGR in FIG. 6. The cell nuclei appear in white as opposed to the rest, which appears in black in the nuclei mask MH.

According to a preferred embodiment, the invention provides that a processing 100 can include a step 140 consisting of implementing a logical “AND” operation between the mask of the section MS generated in step 101 and all or part of the parenchyma masks MP, the muscle cells mask MD, or the nuclei mask MH. Such an operation 140 consists, for each pixel MS(i,j) of the mask of the section not depicting the section of the organ, of assigning to the corresponding pixels of the parenchyma masks MP, muscle cells MD and cell nuclei MH, the second respective characteristic values provided for constituting such masks. Thus, in all the masks MP, MD and MH, such corresponding pixels all depict the Boolean value “false”.

The second main processing 200 of a method P according to the invention will now be examined, through two preferred but non-limitative embodiments. It is recalled that such a processing 200 consists of using jointly the digital representations MD, MP or MH generated in the processing 100 for identifying the components of interest of the section, in this case, with reference to the example illustrated by FIG. 5, the muscularized vessels supplying the section of a pulmonary lobe. Such a processing 200 consists, iteratively, of identifying, in a step 210, a vessel Vx, then in a step 220, measuring the lumen, the intima and the media thereof, in order ultimately to generate, in a step 230, one or more morphometric measurements QIx of said vessel Vx. Such an iterative processing 200 is continued (situation illustrated by the test 250 and the link 250-y in FIG. 4) as long as a vessel can still be identified. It finishes (situation illustrated by the test 250 and the link 250-n in FIG. 4) when all of the information available in the different digital representations MP, MD and/or MH has been used. Such a processing 200 can include a test 240 intended to confirm or invalidate the identification of a component of interest as a vessel. Such a test 240 thus aims to rule out (situation illustrated by the link 240-n in FIG. 4) certain identified components since although they have certain morphological criteria in common with the vessels, their arrangements and/or proportions between muscle cells and other cells teach that they depict other components such as bronchi or bronchioles. In fact the cell nuclei stained with haematoxylin, according to the example illustrated by FIG. 6, are much more numerous in the bronchi/bronchioles than those of the endothelial cells forming the intima of a muscularized vessel. The quality and the accuracy of the quantifications of such nuclei or proportions permitted by the invention in fact make it possible to reject certain false components of interest and greatly increase the relevance of the analysis of vascularized organs. Only the morphometric measurements QIx thus produced for components of interest (the vessels) are subject to storage (situation illustrated by the link 240-y) in a suitable data structure in the data memory 14 of the medical imaging system 1 implementing the method P.

A first embodiment of the processing 200 is described with reference to FIGS. 10 to 12. The step 210 consists of determining in the muscle cells mask MD at least one polygon of interest that will be called “vessel polygons” PVx. FIG. 10 thus presents a triptych of three representations, at the centre a partial enlargement of FIG. 6 focussed on the component of interest Vx. The partial enlargement corresponding to said mask MD is illustrated on the left in FIG. 10. The muscle cells appear here in white, unlike the rest of the tissue or a blank, which appears in black. Such a step 210 can consist of calculating the respective signed surface areas of such polygons using the Green-Riemann formula in order to retain only the polygons having positive surface areas and reject the polygons having negative surface areas. In a variant, such a step 210 could implement the Shoelace formula, also known as “shoelace formula or algorithm”, for calculating signed surface areas of simple polygons. The right-hand part in FIG. 10 thus illustrates, by superposition for illustration purposes, such a vessel polygon PVx (represented by a surface area hatched with oblique bars coloured black on a white background) on the extract of the representation BGR depicted in the centre of said FIG. 10. According to this first embodiment, the test 240 can consist of only considering as polygons of interest, in this case those depicting vessels, the polygons PVx having areas greater than a predetermined threshold, for example, according to the example in FIG. 10, equal to one hundred square micrometres.

The step 220 of such a first embodiment of the processing 200 can then consist of identifying lumen, intima and media of such a vessel Vx. FIGS. 11 and 12 make it possible to illustrate this operation 210. FIG. 11 presents a triptych, according to which on the left is depicted the same extract of the muscle cells mask MD depicted on the left in FIG. 10. In the centre in FIG. 11 the same extract of said mask MD is illustrated, but inverted, denoted MD-1 in FIG. 11. Only the pixels captured by the vessel polygon PVx identified in step 210 are depicted therein. Thus, the central view in FIG. 11 depicts in black the pixels (depicting muscle cells, therefore the media) corresponding to those appearing in white in the left view in said FIG. 11, if and only if said pixels are captured or comprised by said polygon PVx depicted in FIG. 10. Similarly, the central view in FIG. 11 depicts in white the pixels (depicting the lumen or the intima) corresponding to those appearing in black in the left view in said FIG. 11, if and only if said pixels are captured or comprised by said vessel polygon PVx depicted in FIG. 10. The step 220 now consists of determining in such a mask MD-1 the polygons depicted by such pixels captured by said vessel polygon PVx. Only the polygons having positive surface areas greater than a determined minimum threshold (for example of a value less than five percent, preferably one percent, of the surface area of the vessel polygon PVx) are retained and assigned to the lumen Lx of the vessel Vx. Such polygons PIx are classified as “inner polygons”. The right-hand part in FIG. 11 thus shows, for illustration purposes, such an inner polygon PVx (represented by a surface area hatched with vertical bars) superposed on the vessel polygon PVx (represented by a surface area hatched with oblique bars) on the extract of the representation BGR depicted in the centre of said FIG. 10. The media Mx is thus distinguished by subtracting the inner polygon PIx from the vessel polygon PVx. The latter is thus visualized by the surface area hatched with oblique bars remaining visible.

FIG. 12 illustrates the step 220 for distinguishing the intima and the lumen of a vessel Vx from an inner polygon PIx. FIG. 12 presents a triptych, according to which on the left is depicted the extract of the parenchyma mask MP corresponding to the extract of the mask MD depicted on the left in FIG. 10. This view on the left thus depicts in white the non-muscle cells associated with the pixels of said mask MP captured by an inner polygon PIx identified beforehand. In the centre in FIG. 12 the same extract of said mask MP is illustrated, but inverted, denoted MP-1 in FIG. 12. Only the pixels captured by the inner polygon PIx calculated beforehand are depicted therein. Thus, the central view in FIG. 12 depicts in black the pixels (depicting non-muscle cells, therefore the intima) corresponding to those appearing in white in the left view in said FIG. 12, if and only if said pixels are captured by said polygon PIx depicted in FIG. 11. Similarly, the central view in FIG. 12 depicts in white the pixels (depicting the lumen) corresponding to those appearing in black in the left view in said FIG. 12, if and only if said pixels are captured by said inner polygon PIx depicted in FIG. 11. The step 220 now consists of determining in such a mask MP-1 the polygons depicted by such pixels captured by said vessel polygon PVx. Only the polygons having positive surface areas greater than a determined minimum surface area (for example comprised between five and thirty, advantageously ten, square micrometres) are retained and assigned to the lumen or lumens Lx of the vessel Vx. Such polygons PLx are classified as “lumen polygons”. The right-hand part in FIG. 12 shows, for illustration purposes, such a lumen polygon PLx (represented by a surface area hatched with intersecting bars) superposed on the inner polygon PIx (represented by a surface area hatched with vertical bars) itself superimposed beforehand on the vessel polygon PVx (represented by a surface area hatched with oblique bars), the whole superimposed on the extract of the representation BGR depicted in the centre of said FIG. 10. The intima is thus distinguished by subtracting the lumen polygon PIx from the inner polygon PIx. The latter is thus visualized by the surface area hatched with vertical bars remaining visible. Thus, at the end of the implementation of the step 220, the lumen, the intima and the media are identified and determined for the vessel Vx.

The step 230 of a processing 200 according to this first embodiment now consists of quantifying one or more morphometric measurements QIx of the vessel Vx thus identified in 210, the structure of which (lumen, intima and media) was determined in 220. By way of non-limitative example, for each identified vessel Vx, a measurement of interest QIx can consist of the area ALx of the lumen Lx that corresponds to the polygon PLx, the area AIx of the intima Ix resulting from the subtraction of said area ALx from the inner polygon PIx, and/or the area AMx of the media Mx resulting from the subtraction of said inner polygon PIx from the vessel polygon PVx. Such a measurement QIx can also or in a variant consist of the radius RLx of the lumen Lx. Such a radius RLx can be calculated as:

$$RLx = \sqrt{\frac{ALx}{π}}$$

Such a morphometric measurement QIx can also, or in a variant, consist of the thickness EIx of the intima Ix, calculated such that:

$$EIx = \sqrt{\frac{ALx + AIx}{π}} - RLx$$

Such a morphometric measurement QIx can also, or in a variant, consist of the thickness EMx of the media Mx, calculated such that:

$$EMx = \sqrt{\frac{AMx + AIx + ALx}{π}} - EIx - RLx$$

Such a morphometric measurement QIx can also, or in a variant, consist of the thickness EVx of the vessel such that EVx=EIx+EMx.

Such a morphometric measurement QIx can also, or in a variant, consist of the thickness EIRx of the intima Ix with respect to the total radius of the vessel RVx, calculated such that:

$$EIRx = \frac{EIx}{RLx + EIx + EMx}$$

Such a morphometric measurement QIx can also, or in a variant, consist of the thickness EMx of the media Mx with respect to the total radius of the vessel RVx calculated such that:

$$EMRx = \frac{EMx}{RLx + EIx + EMx}$$

Such a morphometric measurement QIx can also, or in a variant, consist of the thickness EVx of the vessel with respect to the total radius of the vessel RVx calculated such that:

$$EVRx = \frac{EVx}{RLx + EIx + EMx}$$

Such a morphometric measurement QIx can also, or in a variant, consist of the total radius RVx=EDx/2 of the vessel Vx, calculated such that:

$$RVx = RLx + EIx + EMx$$

Such a morphometric measurement QIx can also, or in a variant, consist of a ratio of obstruction ORx of the vessel Vx, calculated such that:

$$ORx = 1 - \frac{RLx}{RVx}$$

A vessel Vx can include several lumens and therefore several intima. The step 220 can in fact identify a plurality of lumen polygons PLx within one and the same inner polygon PIx. In this case the invention provides that a morphometric measurement QIx can also consist of the sum of the areas ALx respectively associated with the lumens. Similarly, such a morphometric measurement QIx can consist of the sum of the areas AIx respectively associated with the intima.

The invention should not be regarded as limited by these examples alone of morphometric measurements QIx of a vessel Vx alone.

Said invention also relates to a second embodiment of the processing 200 of a method P. Such a second embodiment is particularly efficient for identifying and measuring the lumen, intima and media of a vessel when the outer polyline surrounding said media may appear discontinuous on the digital representation BGR. This is the case for example of the vessel Vy depicting an annular structure, oblong in shape, certain segments of which are not visualized by a brown colour in FIG. 6. The two embodiments of the processing 200 can furthermore be implemented in a complementary or successive manner in order to complete the detection or identification of the vessels Vx and Vy vascularizing an organ OG. In this case, the invention provides for the pixels of the muscle cells mask MD and/or the parenchyma mask MP, said pixels being captured by, or depicting, a vessel polygon PVx calculated in step 210 according to the first embodiment, to be assigned, after the implementation of the step 230 of such an iterative processing 200, to generate morphometric measurements QIx of a vessel, to the second characteristic value signifying that said corresponding pixels no longer depict a muscle cell or a parenchyma cell. In this way, the implementation of an iterative instance of the processing 200 relying on the second embodiment, succeeding that of said processing 200 relying on the first embodiment, does not result in possible redundant identifications of vessels.

According to this second embodiment, the step 210 consists of determining if the pixels of the parenchyma mask MP depict one or more polygons. Like the step 210 according to the first embodiment, such a detection can rely on the signed calculation of the surface area of each polygon identified using the Green-Riemann formula. Said step 210 however consists of retaining only the polygons delimiting a blank space, i.e. the measured surface area of which is negative, and rejecting the polygons with positive surface areas. Such retained polygons correspond to potential lumens that will be called “potential lumen polygons”.

FIG. 13 illustrates such an operation performed in the step 210. Said FIG. 13 thus presents a triptych of three representations, at the centre a partial enlargement from FIG. 6 focussed on the component of interest Vy. The partial enlargement corresponding to said parenchyma mask MP is illustrated on the left in FIG. 13. The tissue appears here in white, unlike the blank, which appears in black. The right-hand part in FIG. 13 illustrates the superposition, for illustration purposes, of a potential lumen polygon PLy (represented by a surface area hatched with intersecting oblique bars or meshed) on the extract of the representation BGR depicted in the centre of said FIG. 13. According to this second embodiment of the processing 200, a test 240 can consist of considering as components of interest, in this case potential lumens, only those associated with areas PLy greater than a predetermined threshold, for example, according to the example in FIG. 13, equal to one hundred square micrometres in absolute value. In this way the intercellular spaces, for example, are disregarded. Moreover, such a test 240 can also consist of evaluating the circularity c of the component or polygon PLy. Such a circularity c can be estimated by the following calculation:

$$C = \frac{2 \cdot \sqrt{\frac{PLy}{π}}}{SDFy}$$

where PLy is the area determined by the potential lumen polygon and SDFy is the small Feret diameter of said polygon or area PLy. The invention provides to reject or disregard the polygons PLy the circularity c of which is less than a determined threshold, for example less than “0.3”, advantageously equal to “0.1”. Such a test 240 advantageously makes it possible to dispense with the “roundness” of the vessel a lumen of which is potentially identified. In fact, if said vessel is substantially longitudinal on the section S of the analyzed organ OG, the fact of only considering the small Feret diameter makes it possible to estimate reasonably the real diameter of the lumen of said vessel. Such a small Feret diameter is also depicted by FIG. 13 under the reference SDFy, obtained for example by taking the short side of a rectangular box, represented by a discontinuous line in said FIG. 13, circumscribing the component of interest Vy.

The step 220 of the treatment 200, according to this second embodiment, consists firstly of identifying the intima Iy of a vessel Vy a potential lumen Ly of which was identified via a polygon PLy in step 210. Such a determination of the intima Iy can be performed by using an algorithm known as “Watershed”. Such an algorithm makes it possible to segment an image in the form of a matrix representation the pixels or elements of which determine the grey levels (or luminous intensities of integer values generally comprised between zero and two hundred and fifty-five). This type of algorithm originates from the mathematical morphology that considers a greyscale image as a topographical relief the flooding of which is simulated. Watershed of said topographical relief is then calculated. The “watersheds” thus obtained correspond to the regions of the divide. With reference to FIG. 14 that depicts a mosaic of nine images or digital representations F14a to F14i, the step 220 thus consists of considering a “surrounding box”, i.e. a region of pixels of the muscle cells mask MD including at least the corresponding pixels in the parenchyma mask MP, said corresponding pixels depicting a potential lumen polygon PLy. This region of said mask MD is represented by the image F14a in FIG. 14. The regions of pixels DWA, appearing in white, depict the muscle cells, and the rest appears in black. The step 220 then consists of calculating the “distance map” also called “distance transform” in the form of a new digital representation of the surrounding box of the binary mask MD depicted by the image F14a. It associates with each pixel of the image the distance to the closest obstacle point. These obstacle points can be the points of the contour of shapes in a binary image. Such a digital representation is illustrated by the image F14b in FIG. 14. The minima appear in white and the maxima or potential obstacles for a virtual runoff appear in black. For the purposes of illustration, FIG. 14 depicts an image F14c, identical to the image F14b on which the regions DWA of the muscle cells mask MD have been superposed. Said regions DWA appear in the form of hatched regions and quite naturally cover the high points of the transform map.

The step 220 consists as it were of imposing a grid on the representation F14b or F14c and finding for each box of said grid:
a local maximum situated outside the region of pixels corresponding to the potential lumen polygon PLy determined on the mask MP, such a local maximum is called “external seed”;
a local maximum situated inside the region of pixels corresponding to the potential lumen polygon PLy determined on the mask MP, such a local maximum is called “internal seed”.

The step 220 also consists of creating a vector of lists of points each representing the coordinates of a pixel. The size of said vector corresponds to the maximum luminous intensity of the pixels of the distance transform. Said step 220 also consists of creating a “points mask” in the form of a matrix representation of the points or pixels, so as to characterize or label a point as “external point” or “internal point”. The step 220 then consists, for each external seed, of adding to the vector of the lists of points, the points that are neighbours thereto according to their specific luminous intensities. Said neighbour points are labelled “external points” in the points mask. These are then called “points originating from an external seed”.

The step 220 also consists, for each internal seed, of adding to the vector of the lists of points, the points that are neighbours thereto according to their specific luminous intensities. Said neighbour points are labelled “internal points” in the mask of points. These are then called “points originating from an internal seed”.

The step 220 now consists of an iterative operation consisting of scrolling through the vector of the lists of points, from the list associated with the maximum luminous intensity of the pixels of the distance map to null luminous intensity and, for each list of points in question, scrolling through said list so that for each point of said list:
if said point has originated from an internal seed, said point belongs to the surrounding box of the muscle cells mask MD, said point belongs to the potential lumen polygon PLy taken from the parenchyma mask MP or does not depict a blank in said mask MP, the neighbour points of said point are added to the lists of points of said vector according to their luminous intensities specific to each neighbour point and said neighbour points are labelled as “internal points” in the mask of points;
if the point has originated from an external seed, said point belongs to the surrounding box of the muscle cells mask MD, the neighbour points of said point are added to the lists of points of said vector according to their specific luminous intensities and said neighbour points are labelled as “external points” in the mask of points.

These iterations are illustrated by the images F14d to F14h in FIG. 14 for which the respective pixels depict regions ELP filled with black points on a white background, corresponding to the points labelled as “external points” in the mask of points as the iterations of said operation progress and for which the respective pixels depicting regions ILP hatched with black lines on a white background, correspond to the points labelled as “internal points” in the mask of points as said iterations of said operation progress.

When all of the vector of lists of points has been used (situation illustrated by the image F14h in FIG. 14) said points labelled “internal points” a priori depict the lumen and the intima of a vessel Vy. In order to confirm this hypothesis, the invention provides that the step 220 can consist of determining the “internal” points or pixels that delimit the contour of a region ILP, then quantifying the number of these associated points or pixels the corresponding pixels of which in the muscle cells mask MD have neighbour pixels translating the first determined value of said mask, i.e. translating the Boolean value “true” evidencing that such neighbour pixels depict a muscle cell. When the result of such a quantification translates a proportion greater than a determined threshold, for example eighty percent, the hypothesis according to which the region ILP corresponds to a lumen and an intima is confirmed. Figure F14i in FIG. 14 thus illustrates an image depicting regions ELP associated with the points labelled “external points” and, in this case, a region ILP (it is possible for there to be several of these) associated with the points labelled “internal points”. For teaching purposes, the regions DWA originating from the muscle cells mask are superposed thereon. The set of points labelled “internal points” in the mask of points depict the lumen and intima of the vessel Vy. The image F14i in FIG. 14, as well as FIG. 15 which illustrates an enlargement thereof, thus show a superposition on the first representation BGR of the region ILP constituted beforehand, appearing hatched with vertical lines, the regions DWA depicting the muscle cells appearing in a brown colour on the representation BGR and the potential lumen polygon PLy appearing as a pattern of a grid or intersecting lines. By this superposition, the result is visually perceived of the determination performed by the step 220, the lumen Ly depicted by the polygon PLy, the intima Iy depicted by the area ILP not covered by said polygon PLy and the media My depicted by the muscle cells corresponding to the surface areas DWA of the mask MD of a vessel Vy.

In order to complete this determination, more specifically to characterize the media My of the vessel Vy, the step 220 can now consist, as illustrated by the left part of FIG. 16, of using the region ILP, depicting the lumen Ly and intima Iy, said region ILP being represented in the left part of FIG. 16 hatched with vertical lines, and the regions DWA, represented hatched with oblique lines, originating from the muscle cells mask MD, or more specifically from the surrounding box determined beforehand. Said step 220 can then consist of assigning to the predetermined value translating the Boolean information “true” in said surrounding box the pixels corresponding to the “internal points” of the mask of points. By implementing a flood fill algorithm, the seed or departure point of which is a pixel the corresponding pixel of which in the parenchyma mask MP is captured or belongs to the potential lumen polygon PLy, a resulting vessel polygon is obtained surrounding the media, the intima and the lumen of the vessel Vy. By subtracting the region ILP from said resulting polygon, the media is characterized. The step 220 has thus distinguished a lumen Ly, an intima Iy and a media My of a vessel Vy, as depicted in the right-hand view in FIG. 16. Any other alternative technique to the flood-fill algorithm could be used in a variant in order to arrive at the resulting polygon.

This second embodiment of the processing 200 is therefore particularly suitable for distinguishing vessels the media of which is not fully stained or which appears as an “open” annular structure on the first digital representation BGR, as is the case for the vessel Vy. On the other hand, its implementation is more complex than that of the first embodiment, which however requires media with “closed” annular shapes. It can therefore be particularly advantageous to implement the two instances of said processing 200 sequentially, one according to the first embodiment and the second according to said second embodiment as mentioned above. As the second embodiment is more “permissive” than the first mode, the latter is still likely to take account of non-interest components such as bronchioles or bronchi instead of the vessels Vx and Vy alone when the examined organ OG is a pulmonary lobe. In order to avoid this drawback, the step 240 of such a second embodiment of a processing 200 can also use said nuclei mask MH, mentioned above in connection with the optional step 130 of the processing 100, to confirm (240-y) or invalidate (240-n) the identification of a component of interest as a vessel. In fact, the bronchi or bronchioles generally have an epithelial cell density that is much greater than the density of endothelial cells depicting the intima of a vessel. Thus, advantageously such a test 240 can be implemented to quantify the pixels depicting cell nuclei in the mask MH associated with internal points in the mask of points developed and used in step 220. If the number of such pixels with respect to those associated with the set of said internal points exceeds a determined area (for example an area comprised between twenty and fifty square micrometres, advantageously equal to forty square micrometres), the potential lumen polygon PLy has no need to be considered or is rejected, as it does not depict a lumen of a vessel. The subsequent operations provided in step 220, or the morphometric measurements QIy that originate from the implementation of the step 230 are disregarded or not retained in the data memory of the electronic object implementing such a method P.

Thus, as with the first embodiment of a processing 200, such a step 230 can consist of generating one or more morphometric measurements QIy for the vessel Vy from the following measurements:
the area ALy of the lumen Ly that corresponds to the potential lumen polygon PLy;
the area Aly of the intima Iy resulting from the subtraction of the region ILP from the potential lumen polygon PLy;
the area AMy of the media My resulting from the subtraction of said region ILP from the resulting vessel polygon;
the radius RLy of the lumen Ly such that:

$$RLy = \sqrt{\frac{ALy}{π}}$$

Such a morphometric measurement QIy can also, or in a variant, consist of the thickness Ely of the intima Iy, calculated such that:

$$EIy = \sqrt{\frac{ALy + AIy}{π}} - RLy$$

Such a morphometric measurement QIy can also, or in a variant, consist of the thickness EMy of the media My, calculated such that:

$$EMy = \sqrt{\frac{AMy + AIy + ALy}{π}} - EIy - RLy$$

Such a morphometric measurement QIy can also, or in a variant, consist of the thickness EVy of the vessel (or of the vascular wall) such

$$EVy = EIy + EMy .$$

Such a morphometric measurement QIy can also, or in a variant, consist of the thickness ElRy of the intima Iy with respect to the total radius of the vessel RVy, calculated such that:

$$EIRy = \frac{EIxy}{RLy + EVy}$$

Such a morphometric measurement QIy can also, or in a variant, consist of the thickness EMy of the media My with respect to the total radius of the vessel RVy, calculated such that:

$$EMRy = \frac{EMy}{RLx + EVy}$$

Such a morphometric measurement QIy can also, or in a variant, consist of the thickness EVy of the vessel with respect to the total radius of the vessel RVy, calculated such that:

$$EVRy = \frac{EVy}{RLx + EVy}$$

Such a morphometric measurement QIy can also, or in a variant, consist of the total radius of the RVy of the vessel Vy, calculated such that:

$$RVy = RLy + EIy + EMy$$

Such a morphometric measurement QIy can also, or in a variant, consist of a ratio of obstruction ORy of the vessel Vy, calculated such that:

$$ORy = 1 - \frac{RLy}{RVy}$$

The invention should not be regarded as limited by these examples alone of morphometric measurements QIy of a vessel Vy generated from the second embodiment of the processing 200.

The optional processing 500 of a method P according to the invention will now be examined, through a preferred but non-limitative embodiment illustrated by FIGS. 4 and 4A. It is recalled that such a processing 500 consists of using jointly the digital representations MD, MP or MH generated in the processing 100 for identifying other components of interest within the section, in this case, with reference to the example illustrated by FIG. 5, the plexiform lesions in addition to muscularized vessels supplying the section of a pulmonary lobe identified by the processing 200. Such a processing 500 consists, iteratively, of identifying, in a step 510, structures LS index z positive integer, hereinafter referenced LSz, appearing a priori similar to plexiform lesions, then, in a step 520, measuring one or more morphometric characteristics QILSz thereof per identified structure LSz. Such an iterative processing 500 is continued (situation illustrated by the test 550 and the link 550-y in FIG. 4A) as long as such a structure can still be identified. It finishes (situation illustrated by the test 550 and the link 550-n in FIG. 4A) when all of the information available in the different digital representations MP, MD and/or MH has been used. Such a processing 500 can include a test 530 intended to confirm or invalidate the identification of a plexiform lesion with respect to a structure having similarities. Such a test 530 thus aims to rule out (situation illustrated by the link 530-n in FIG. 4A) certain identified components although they have certain morphological criteria in common with such lesions, by virtue of an analysis of their arrangements and/or proportions between muscle cells and other cells. In fact, the objective of said processing 500 is to count irregular muscular masses having high densities of cell nuclei. Such a test 530 also aims to rule out structures such as, for example, discontinuous muscle masses surrounding the large bronchi when the examined organ is a lung. Such a test 530 could concern in particular said density of cell nuclei stained according to the example illustrated in FIG. 6 by haematoxylin. When a structure of interest depicting a plexiform lesion is confirmed (situation illustrated by the link 530-y) the processing 500 includes a step 540 for incrementing by one unit the value of a counter of structures or of lesions, the current value of which is the object of storage in a suitable data structure in the data memory 14 of the electronic object or of the system 1 implementing the method P. Ultimately, the value of said counter or the number of plexiform lesions, optionally normalized by the area of the examined section S, constitutes an additional quantity of interest QIL, capable of being used by the processings 300 and/or 400 to generate one or more quantities of interest QI and/or one or more associated graphic indicators IG of the examined organ.

A preferred but non-limitative embodiment of the processing 500 will be described with reference to FIGS. 4A, 17 to 21. A step 510 consists of determining in the muscle cells mask MD all the polygons that will be called “lesion polygons” PLSz. FIG. 17 thus presents a triptych of three representations, at the centre a partial enlargement of the digital representation BGR, an extract of which is illustrated in FIG. 6, focussed on a component of interest LSz. The partial enlargement corresponding to said mask MD is illustrated on the left in FIG. 17. The muscle cells appear here in white, unlike the rest of the tissue or a blank, which appears in black. Such a step 510 can consist of calculating the respective signed surface areas of such polygons PLSz using the Green-Riemann formula in order to retain only the polygons having positive surface areas and reject the polygons having negative surface areas. In a variant, such a step 510, like step 210, could implement the Shoelace formula, also known as “shoelace algorithm”, for calculating signed surface areas. The right-hand part in FIG. 17 thus illustrates, by superposition for illustration purposes, such a lesion polygon PLSz (represented by a surface area hatched with oblique bars coloured black on a white background) on the extract of the representation BGR depicted in the centre of said FIG. 17. According to this embodiment, the test 530 can first consist of considering as polygons PLSz of interest, in this case those depicting the plexiform lesions, only the polygons PLSz having areas greater than a predetermined threshold, for example, according to the example in FIG. 17, equal to one thousand square micrometres. In fact, such structures having sizes that are too small, i.e. the respective polygons PLSz of which would be below said threshold, would be insufficient to evidence a significant advance in a pathology such as pulmonary arterial hypertension. The invention is not to be considered limited by this choice of threshold.

The step 520 of such an embodiment of the processing 500 can then consist of quantifying and evaluating certain morphological parameters QILSz of a plexiform lesion LSz identified a priori by the detection of the polygon PLSz in the muscle cells mask MD. FIG. 18 illustrates the determination of a first morphological parameter QILSz implemented in step 520. Said FIG. 18 shows four images F18a to F18d. The image F18a depicts the extract of the muscle cells mask MD illustrated on the left in FIG. 17. The image F18b depicts one and the same extract of the muscle cells mask MD that is depicted therein on the left in FIG. 17 but where the pixels external to the lesion polygon PLSz have been assigned to the determined value (in this case zero) symbolizing the Boolean value “false”. One of said morphological parameters QILSz of an identified structure LSz can consist of the result of a calculation of a morphological gradient of said muscle cells mask MD in the interior of said lesion polygon PLSz. To this end, such a step 520 can advantageously consist of a morphological dilatation of the extract of said muscle cells mask MD depicted by the image F18b. The result of such an operation is illustrated by the third image F18c in FIG. 18. The image 18d, for its part, reveals an enlargement of the result of the subtraction, implemented in step 520, of the original mask, depicted by the image F18b, from said mask after having undergone the morphological dilation. The result of said subtraction operation, illustrated by the image F18d, is the gradient of the muscle cells mask within a lesion polygon PLSz. Such a result can be called “gradient mask” MG and depicts in the form of a binary digital matrix representation, having the same dimensions as the muscle cells mask MD, only the pixels describing the Boolean value “true”, for example of integer value equal to two hundred and fifty-five, whose corresponding pixels within the images F18b and F18c (illustrating respectively the original mask MD covered by a lesion polygon PLSz and said mask after implementation of the morphological dilatation operation) are not identical. The other pixels of said gradient mask MG depict the Boolean value “false”, for example being assigned to the integer value equal to zero. In order to obtain a first parameter of interest QILSz, the step 520 can consist of calculating a ratio of the number of pixels of the gradient mask MG, depicting the value “true” to the total number of pixels of said polygon PLSz. The test 530 can then consist of not considering (situation illustrated by the link 530-n) a structure LSz as depicting a plexiform lesion of interest, when such a ratio QILSz is less than a determined threshold, for example, the value of which is comprised between fifty and eighty percent. Advantageously, such a threshold could be set or parameterized at seventy percent. On the other hand, said test 530 could recognize (situation illustrated by the link 530-y) such a plexiform lesion if the value of said ratio is greater than or equal to said threshold, translating an irregularity of staining of the muscle cells in said mask MD evidencing an uncontrolled development of the muscle tissue.

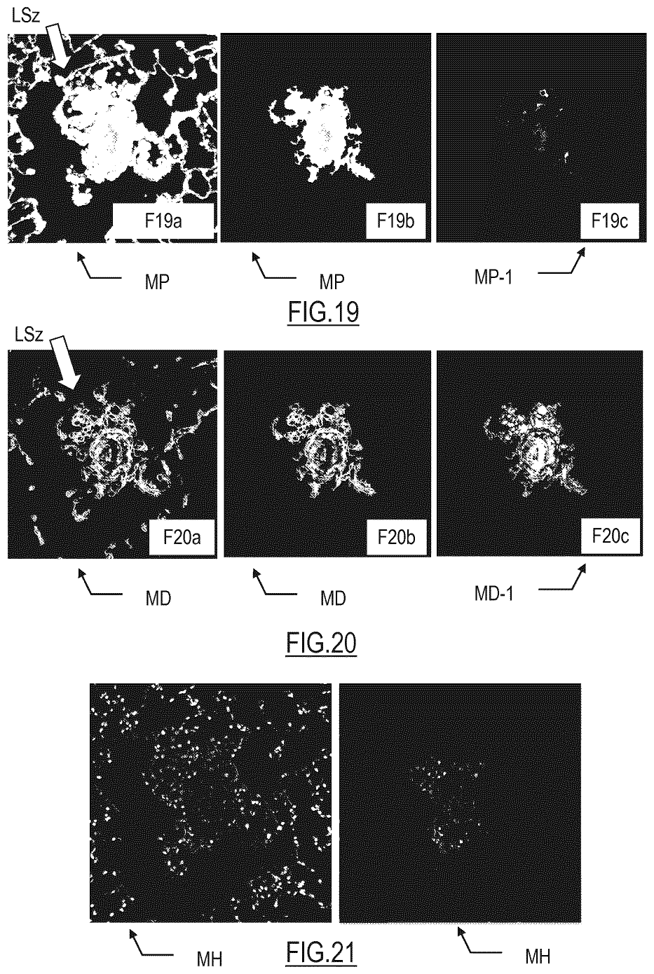

The invention provides for the step 520 to also generate a second morphological parameter QILSz of a lesion polygon PLSz identified in step 510, to characterize the latter as being relatively full or otherwise as capturing a blank, one or more “holes” or lumina within it. The purpose of generating such a second parameter QILSz then advantageous use thereof by the test 530 is intended to avoid confusion between a lesion polygon PLSz erroneously detected while the latter should rather be characterized as being a vessel polygon, similar to the polygon PVx depicted in FIG. 10. In order to detect the presence of one or more lumina captured by a lesion polygon PLSz, the invention provides for the step 520 to consist of determining all the polygons present in the parenchyma mask MP, after the latter has been inverted (i.e. the pixels of the parenchyma mask MP translating the Boolean value “true” translate the Boolean value “false” in the inverted mask MP-1 and those of the parenchyma mask MP translating the Boolean value “false” translate the Boolean value “true” in the inverted mask MP-1). FIG. 19 illustrates such an operation, said mask MP-1 being delimited by said polygon PLSz. Said FIG. 19 thus presents a triptych of three representations or images F19a to F19c. The representation on the left F19a illustrates a partial enlargement of the parenchyma mask MP, generated in step 110 of the processing 100, an extract of which is illustrated by FIG. 7, focussed on the structure of interest LSz. In the centre of FIG. 19, an image F19b depicts said extract of the parenchyma mask MP only the pixels of which, the corresponding pixels of which within the muscle cells mask MD are captured by the lesion polygon PLSz associated with said structure LSz, can depict the Boolean value “true”. The other pixels are assigned to the null integer value translating the Boolean value “false”. FIG. 19 illustrates on the right (image F19c), the inverted image MP-1 of the image F19b in the centre of FIG. 19. Thus, only the pixels of said image F19c that appear in white (therefore describing the Boolean value “true” or containing an integer value equal to two hundred and fifty-five) depict a blank. The step 520 then consists of determining and measuring all polygons present in said inverted parenchyma mask MP-1, these latter being delimited by said polygon PLSz as illustrated by the image F19c. The second morphological parameter QILSz of a lesion polygon PLSz then consists of measuring the largest of said determined polygons. The test 530 can then consist of not considering (situation illustrated by the link 530-n) a structure LSz as depicting a plexiform lesion of interest, but potentially a vessel said parameter QILSz of which could translate the area of a lumen, when such a parameter QILSz describes an area greater than a percentage, or relative threshold, of the total surface area of the identified lesion polygon PLSz. Such a threshold with respect to the total surface area of said polygon PLSz could be set or parameterized at a value less than ten percent, advantageously equal to five percent. On the other hand, said test 530 could recognize (situation illustrated by the link 530-y) such a plexiform lesion if the value of the parameter QILSz is less than or equal to said threshold.

The invention provides to generate a third morphological parameter QILSz of a lesion polygon PLSz identified in step 510. The second parameter consisted of measuring or quantifying the presence of holes or a blank in the tissue circumscribed by said polygon PLSz. To this end, the step 520 used the parenchyma mask MP, more precisely its inverse mask MP-1. Such a third parameter consists of measuring or quantifying the presence of holes or a blank in the tissue circumscribed by said polygon PLSz. To this end, the step 520 consists of similarly exploiting the muscle cells mask MD, more precisely its inverse MD-1, as illustrated by FIG. 20.

Said FIG. 20 thus presents a triptych of three representations or images F20a to F20c. The representation on the left F20a illustrates a partial enlargement of the muscle cells mask MD, generated by the step 120 of the processing 100, an extract of which is illustrated by FIG. 8, focussed on the structure of interest LSz. In the centre of FIG. 20, an image F20b depicts said extract of the muscle cells mask MD only the pixels of which captured by the lesion polygon PLSz associated with said structure LSz can depict the Boolean value “true”. The other pixels are assigned to the null integer value translating the Boolean value “false”. The image F20c in FIG. 20 corresponds to the inverted image F20b, i.e. only the pixels of said image F20c that appear in white (therefore describing the Boolean value “true” or containing an integer value equal to two hundred and fifty-five) do not depict muscle cells. The step 520 then consists of determining and measuring all polygons present in said inverted muscle cells mask MD-1, these latter being delimited by said polygon PLSz as illustrated by the image F20c. The third morphological parameter QILSz of an identified lesion polygon PLSz then consists of measuring the largest of said determined polygons. The test 530 can then consist of not considering (situation illustrated by the link 530-n) a structure LSz as describing a plexiform lesion of interest, but potentially a discontinuous muscle mass surrounding a large bronchus, when such a parameter QILSz describes an area less than a percentage, or relative threshold, of the total surface area of the identified lesion polygon PLSz. Such a threshold with respect to the total surface area of said polygon PLSz could be set or parameterized at a value less than ten percent, advantageously equal to five percent. On the other hand, said test 530 could recognize (situation illustrated by the link 530-y) such a plexiform lesion if the value of the parameter QILSz is greater than or equal to said threshold.

The invention provides to generate a fourth morphological parameter QILSz of a lesion polygon PLSz identified in step 510. Said fourth parameter consists of quantifying a number of pixels, from those captured by such a lesion polygon PLSz, within the nuclei mask MH generated in step 130 of the processing 100. Such an operation is illustrated by FIG. 21, showing two views of the nuclei mask MH. The representation on the left illustrates a partial enlargement of the nuclei mask MH, generated by the step 130 of the processing 100, an extract of which is illustrated by FIG. 9, focussed on the structure of interest LSz. FIG. 21 shows on the right, an image depicting said extract of the nuclei mask MH only the pixels of which captured by the lesion polygon PLSz associated with said structure LSz can depict the Boolean value “true”. The other pixels are assigned to the null integer value translating the Boolean value “false”. The step 520 then consists of determining and measuring all polygons present in said nuclei mask MH, these latter being circumscribed by said polygon PLSz as illustrated by the image on the right in FIG. 21. The fourth morphological parameter QILSz of an identified lesion polygon PLSz then consists of the sum of said determined polygons. The test 530 can then consist of not considering (situation illustrated by the link 530-n) a structure LSz as describing a plexiform lesion of interest, when such a parameter QILSz depicts a resulting area less than a percentage, or relative threshold, of the total surface area of the identified lesion polygon PLSz. Such a threshold with respect to the total surface area of said polygon PLSz could be set or parameterized at a value less than five percent, advantageously equal to one percent. On the other hand, said test 530 could recognize (situation illustrated by the link 530-y) such a plexiform lesion if the value of the parameter QILSz is greater than or equal to said threshold.

The invention provides to generate a fifth morphological parameter QILSz of a lesion polygon PLSz identified in step 510. Said fifth parameter consists of quantifying the compactness of such a lesion polygon PLSz identified in step 510. Such a quantification of the compactness of a polygon performed in step 520 can be the result of a calculation of a ratio of the area of said lesion polygon PLSz to the area of its convex envelope. The test 530 can then consist of not considering (situation illustrated by the link 530-n) a structure LSz as describing a plexiform lesion of interest, when such a fifth parameter QILSz depicts a compacity less than a threshold the value of which can be comprised between thirty and sixty percent, advantageously equal to fifty percent. On the other hand, said test 530 could recognize (situation illustrated by the link 530-y) such a plexiform lesion if the value of the parameter QILSz is greater than or equal to said threshold.

Implementation of the test 530 on the basis of one or more morphological parameters QILSz as described above, thus makes it possible to count in the step 540 only the plexiform lesions of interest. Generating the quantity QIL is thus made more reliable. Implementation of the processing 300 can thus use for generating the quantity or quantities of interest QI, or the graphical indicator IG if necessary, such a number of plexiform lesions QIL, this number optionally being normalized by the area of the analyzed section S, in addition to the morphometric analysis of the vascularization of an organ originating from the implementation of the processing 200.

The invention is not to be equally restricted to analysis of a section of a human or animal lung, but relates to other vascularized organs, such as, non-limitatively, the liver. In this case, the additional quantity of interest QIL would reveal the presence of lesions equivalent to the plexiform lesions mentioned in the context of the lung, such as hypercellular or degenerative lesions.

1. A method for generating a morphometric quantity of interest of a section of a human or animal organ, from a first digital representation of a histological section, said first digital representation consisting of a pixel table each pixel encoding a set of integer values respectively describing luminous intensities of primary colours, said method being implemented by a processing unit of an electronic object, said electronic object also including an output human-machine interface and a data memory, characterized in that:
a. the histological section was subjected to a staining step, prior to its digitization, in order to generate said first digital representation, said staining causing distinct colourings of the pixels of said first digital representation when these latter depict a blank, tissue and muscle cells; and
b. said method includes:
i. a step of distinguishing the pixels of said first digital representation depicting tissue from those depicting a blank and forming a “parenchyma mask” in the form of a second digital representation having the same dimensions as the first digital representation, each pixel of which depicts:
a first characteristic value when the corresponding pixel in the first digital representation depicts tissue;
a second characteristic value when said corresponding pixel in the first digital representation depicts a blank;
ii. a step of distinguishing the pixels of said first digital representation depicting muscle cells and forming a “muscle cells mask” in the form of a third digital representation having the same dimensions as the first digital representation, each pixel of which depicts:
a first characteristic value when the corresponding pixel in the first digital representation depicts a muscle cell;
a second characteristic value otherwise;
iii. an iterative step of analysis of the second and third digital representations consisting of:
identifying the pixels depicting at least one polygon of interest within one of the second and third digital representations;
distinguishing, from said second and third digital representations and from the at least one identified polygon of interest, a lumen, an intima and a media of a vessel;
generating at least one morphometric measurement from said lumen, intima and/or media of said vessel and storing said at least one morphometric measurement in the data memory;
iv. a step of generating a morphometric quantity of interest of the tissue of the human or animal organ from at least one morphometric measurement of a vessel stored in the data memory; and
v. a step of causing an output of said morphometric quantity of interest via the output human-machine interface.

2. The method according to claim 1 including a step of distinguishing the pixels of interest of said first digital representation and forming a “section mask” in the form of a fourth digital representation having the same dimensions as the first digital representation, each pixel of which depicts a first characteristic value when the corresponding pixel in the first digital representation depicts the section of the organ and a second characteristic value otherwise.

3. The method according to claim 2, including a step, for each pixel not describing the section of the organ, of assigning second respective characteristic values to the corresponding pixels of the second and third digital representations.

4. The method according to claim 1, including a step of confirmation or invalidation of the identification of a polygon of interest depicting a vessel, said at least one generated morphometric measurement of a vessel only being stored in the data memory if said step of confirmation or invalidation confirms the identification of a polygon of interest depicting a vessel.

5. The method according to claim 4, for which;
a. the prior step of staining the histological section moreover causes distinct colouring of the pixels depicting the cell nuclei of the tissue;
b. said method includes a step of distinguishing the pixels of said first digital representation depicting cell nuclei and forming a “nuclei mask” in the form of a fifth digital representation having the same dimensions as the first digital representation, each pixel of which depicts:
i. a first characteristic value when the corresponding pixel in the first digital representation depicts a cell nucleus;
ii. a second characteristic value otherwise, and
c. the step of confirmation or invalidation of the identification of a polygon of interest depicting a vessel is arranged to use the muscle cells mask and said nuclei mask jointly.

6. The method according to claim 1, for which the at least one morphometric measurement of the lumen, intima and/or media of an identified vessel belongs to a set including the area of the lumen, the area of the intima, the area of the media, the radius of the lumen, the thickness of the intima, the thickness of the media, the thickness of the vessel wall consisting of the sum of the thicknesses of the intima and of the media, the respective thicknesses of the intima, the media, of the vessel wall with respect to the total radius of the vessel consisting of the radius of the lumen to which are added the thicknesses of the intima and of the media, said total radius of the vessel, a ratio of obstruction of said vessel.

7. The method according to claim 1, for which a quantity of interest consists of calculating a mean value of at least one morphometric measurement from a plurality of vessels, calculating such a mean value normalized by the area of the section examined, or also normalized by a determined number of vessels present in said section.

8. The method according to claim 1, including an iterative step of joint analysis of the second and third digital representations consisting of:
identifying the pixels depicting one or more tissue structures of interest in the form of at least one lesion polygon;
generating at least one morphometric measurement from each identified lesion polygon;
confirming or invalidating the identification of a structure of interest as a pathological lesion from said at least one morphometric measurement from each identified lesion polygon;
incrementing by one unit the value of a counter of pathological lesions when the identification of a structure of interest as pathological lesion is confirmed; and
generating an additional morphometric quantity of interest from the value of said counter of pathological lesions.

9. The method according to claim 7, for which the step of generating a morphometric quantity of interest from the tissue of the human or animal organ from said measurements uses jointly the additional morphometric quantity of interest and the morphometric measurements from the identified vessels.

10. The method (P) according to claim 5, for which the step of generating at least one morphometric measurement from each identified lesion polygon consists of adding polygons present in the nuclei mask that are circumscribed by said lesion polygon.

11. The method according to claim 1, for which the step of staining the histological section causing distinct colourings of the blank, of the tissue, and of the muscle cells, consists of jointly performing a colouring with haematoxylin and immuno-histochemistry staining the alpha-smooth muscle actin protein using a chromogen.

12. Computer program product including one or more program instructions that can be interpreted by the processing unit of an electronic object, said program instructions being capable of being loaded into a non-volatile memory of said electronic object characterized in that the execution of said instructions by said processing unit causes the implementation of a method according to claim 1.

13. Computer-readable storage medium containing the instructions of a computer program product according to claim 12.

14. Electronic object including a processing unit, a data memory, a program memory, an output human-machine interface, when said program memory includes the program instructions of a computer program product according to claim 12.
